(19) United States
(12) Patent Application Publication
(10) Pub. No.: US 2026/0196415 A1
(43) Pub. Date: Jul. 9, 2026

(54) PASSIVE ELECTRONIC COMPONENT

(71) Applicant: Murata Manufacturing Co., Ltd, Nagaokakyo-shi (JP)

(72) Inventors: Masatomi HARADA, Nagaokakyo-shi (JP); Korekiyo Ito, Nagaokakyo-shi (JP); Takeshi Kagawa, Nagaokakyo-shi (JP); Yuta Imamura, Nagaokakyo-shi (JP)

(21) Appl. No.: 19/551,693

(22) Filed: Feb. 27, 2026

Related U.S. Application Data
(63) Continuation of application No. PCT/JP2024/029567, filed on Aug. 21, 2024.

(30) Foreign Application Priority Data
Sep. 8, 2023 (JP) 2023-146226

(51) Int. Cl. H01G 4/38; H01G 4/012; H01G 4/252

(52) U.S. Cl. CPC H01G 4/38; H01G 4/012; H01G 4/252

(57) ABSTRACT

A passive electronic component that includes: a substrate having a first main surface and a second main surface that face away from each other in a first direction; and a plurality of capacitors on a first main surface side of the substrate, in which the plurality of capacitors include a first capacitor and a second capacitor spaced apart from each other in a second direction orthogonal to the first direction, the first capacitor includes a first inner electrode layer, a first dielectric layer, and a second inner electrode layer, the second capacitor includes a third inner electrode layer, a second dielectric layer, and a fourth inner electrode layer, and at least a portion of the second inner electrode layer and at least a portion of the third inner electrode layer are in contact with a surface of the first dielectric layer on an opposite side thereof from the substrate.

### CROSS REFERENCE TO RELATED APPLICATIONS

The present application is a continuation of International application No. PCT/JP2024/029567, filed August 21, 2024, which claims priority to Japanese Patent Application No. 2023-146226, filed September 8, 2023, the entire contents of each of which are incorporated herein by reference.

### TECHNICAL FIELD

The present disclosure relates to a passive electronic component.

### BACKGROUND ART

Patent Document 1 discloses an electronic component including a plurality of conductor layers laminated on a substrate, a first capacitor formed of two conductor layers of the plurality of conductor layers that are adjacent to each other in a lamination direction and a dielectric film located between the two conductor layers, a second capacitor formed of two conductor layers of the plurality of conductor layers that are adjacent to each other in the lamination direction and a dielectric film located between the two conductor layers, in which the dielectric film that constitutes the first capacitor and the dielectric film that constitutes the second capacitor have different thicknesses from each other.

Patent Document 1: Japanese Unexamined Patent Application Publication No. 2022-130066

### SUMMARY OF THE DISCLOSURE

The electronic component described in Patent Document 1, for example, the electronic component 1 illustrated in FIG. 2 of Patent Document 1, includes, as the plurality of capacitors, a first capacitor including a conductor pattern 25, a first dielectric film 4, and a conductor pattern 31, a second capacitor including a conductor pattern 26, a second dielectric film 5, and a conductor pattern 32, and a third capacitor including the conductor pattern 25, the first dielectric film 4, the second dielectric film 5, and a conductor pattern 33.

The method of manufacturing the electronic component 1 described in FIG. 2 of Patent Document 1 is illustrated in FIGS. 7 to 15 of Patent Document 1.

In manufacturing the electronic component 1 illustrated in FIG. 2 of Patent Document 1, to form the second dielectric film 5 on the conductor pattern 26, the first dielectric film 4 formed on the conductor pattern 26 in advance is removed by patterning to expose the conductor pattern 26, as illustrated in FIG. 9 of Patent Document 1. However, when the first dielectric film 4 formed on the conductor pattern 26 is removed by patterning, an impurity layer, such as a metal oxide layer or a metal fluoride layer, is formed on a surface of the conductor pattern 26. When the second dielectric film 5 and the conductor pattern 32 are sequentially formed on the conductor pattern 26 as illustrated in FIGS. 11 and 12 of Patent Document 1 in a state in which an impurity layer is formed on the surface of the conductor pattern 26, the dielectric dissipation factor (tanδ) of the impurity layer formed on the surface of the conductor pattern 26 increases in the second capacitor to be obtained. As a result, in the electronic component 1 described in FIG. 2 of the Patent Document 1, the power loss in the second capacitor becomes large, and accordingly, electrical performance with excellent high-frequency characteristics cannot be exhibited.

In addition, in manufacturing the electronic component 1 described in FIG. 2 of Patent Document 1, the conductor pattern 31 is formed on a first region 25A of the conductor pattern 25 via the first dielectric film 4 as illustrated in FIG. 10 of Patent Document 1. The conductor pattern 31 is formed of a multilayer body including a seed layer S and a plating layer P. When the conductor pattern 31 is formed, after the seed layer S is first formed on the entire surface of the first dielectric film 4, patterning of a resist layer is performed on the seed layer S so as to expose the seed layer S in the region (the region overlapping the first region 25A of the conductor pattern 25) in which the conductor pattern 31 is to be formed. Next, electroplating for using the seed layer S as a power feeding body is performed to form a plating layer P on the seed layer S. After that, the resist layer is removed, and the portion of the seed layer S (the portion of the seed layer S in the region in which the plating layer P is not formed) exposed at the surface is removed to form the conductor pattern 31 formed of the multilayer body including the seed layer S and the plating layer P as illustrated in FIG. 10 of Patent Document 1. However, since the seed layer S is removed after the seed layer S is formed on the first dielectric film 4 on which the conductor pattern 31 is not formed in the method described above, for example, on the first dielectric film 4 that covers a second region 25B of the conductor pattern 25, an impurity layer is formed on a surface of the first dielectric film 4 that covers the second region 25B of the conductor pattern 25 due to process damage suffered when the seed layer S is removed. When the second dielectric film 5 and the conductor pattern 33 are sequentially formed on the first dielectric film 4 as illustrated in FIGS. 11 and 12 of Patent Document 1 in a state in which the impurity layer is formed on the surface of the first dielectric film 4 that covers the second region 25B of the conductor pattern 25, the dielectric dissipation factor of the impurity layer formed on a surface of the first dielectric film 4 increases in the third capacitor to be obtained. As a result, in the electronic component 1 described in FIG. 2 of the Patent Document 1, the power loss in the third capacitor becomes large, and accordingly, electrical performance with excellent high-frequency characteristics cannot be exhibited.

As described above, the electronic component described in Patent Document 1 has room for improvement in that electrical performance with good high-frequency characteristics cannot be exhibited in the structure including a plurality of capacitors.

The present disclosure addresses the problem described above with an object of providing a passive electronic component that can exhibit electrical performance with good high-frequency characteristics in the structure including a plurality of capacitors.

A passive electronic component according to the present disclosure includes: a substrate having a first main surface and a second main surface that face away from each other in a first direction; and a plurality of capacitors on a first main surface side of the substrate, in which the plurality of capacitors include a first capacitor and a second capacitor spaced apart from the first capacitor in a second direction orthogonal to the first direction, the first capacitor includes a first capacitance forming portion that includes a first inner electrode layer, a first dielectric layer, and a second inner electrode layer that are arranged sequentially from a substrate side in the first direction, the second capacitor includes a second capacitance forming portion that includes a third inner electrode layer, a second dielectric layer, and a fourth inner electrode layer that are arranged sequentially from the substrate side in the first direction, and at least a portion of the second inner electrode layer and at least a portion of the third inner electrode layer are in contact with a surface of the first dielectric layer on an opposite side thereof from the substrate.

According to the present disclosure, it is possible to provide a passive electronic component that can exhibit electrical performance with better high-frequency characteristics in the structure including a plurality of capacitors.

### BRIEF DESCRIPTION OF THE DRAWINGS

FIG. 1 is a schematic plan view illustrating an example of a passive electronic component according to embodiment 1 of the present disclosure.

FIG. 2 is a schematic cross-sectional view illustrating an example of a cross-section of the passive electronic component illustrated in FIG. 1 taken along line segment a1-a2.

FIG. 3 is a schematic cross-sectional view illustrating a process of preparing a substrate in an example of a method of manufacturing the passive electronic component according to embodiment 1 of the present disclosure.

FIG. 4 is a schematic cross-sectional view illustrating a process of forming an insulating layer in the example of the method of manufacturing the passive electronic component according to embodiment 1 of the present disclosure.

FIG. 5 is a schematic cross-sectional view illustrating a process of forming a first inner electrode layer in the example of the method of manufacturing the passive electronic component according to embodiment 1 of the present disclosure.

FIG. 6 is a schematic cross-sectional view illustrating a process of forming a first dielectric layer in the example of the method of manufacturing the passive electronic component according to embodiment 1 of the present disclosure.

FIG. 7 is a schematic cross-sectional view illustrating a process of forming a second inner electrode layer and a third inner electrode layer in the example of the method of manufacturing the passive electronic component according to embodiment 1 of the present disclosure.

FIG. 8 is a schematic cross-sectional view illustrating a process of forming a second dielectric layer in the example of the method of manufacturing the passive electronic component according to embodiment 1 of the present disclosure.

FIG. 9 is a schematic cross-sectional view illustrating a process of forming a fourth inner electrode layer in the example of the method of manufacturing the passive electronic component according to embodiment 1 of the present disclosure.

FIG. 10 is a schematic cross-sectional view illustrating a process of forming a moisture-resistant protective layer in the example of the method of manufacturing the passive electronic component according to embodiment 1 of the present disclosure.

FIG. 11 is a schematic cross-sectional view illustrating a process of forming a resin protective layer in the example of the method of manufacturing the passive electronic component according to embodiment 1 of the present disclosure.

FIG. 12 is a schematic cross-sectional view illustrating a process of forming a first outer electrode, a second outer electrode, a third outer electrode, and a fourth outer electrode in the example of the method of manufacturing the passive electronic component according to embodiment 1 of the present disclosure.

FIG. 13 is a schematic plan view illustrating another example of the passive electronic component according to embodiment 1 of the present disclosure.

FIG. 14 is a schematic cross-sectional view illustrating an example of a cross-section of the passive electronic component illustrated in FIG. 13 taken along line segment a3-a4.

FIG. 15 is a schematic plan view illustrating an example of a passive electronic component according to embodiment 2 of the present disclosure.

FIG. 16 is a schematic cross-sectional view illustrating an example of a cross-section of the passive electronic component illustrated in FIG. 15 taken along line segment b1-b2.

FIG. 17 is a schematic plan view illustrating another example of the passive electronic component according to embodiment 2 of the present disclosure.

FIG. 18 is a schematic cross-sectional view illustrating an example of a cross-section of the passive electronic component illustrated in FIG. 17 taken along line segment b3-b4.

FIG. 19 is an equivalent circuit diagram illustrating an example of a passive electronic component according to embodiment 3 of the present disclosure.

FIG. 20 is a schematic plan view illustrating the example of the passive electronic component according to embodiment 3 of the present disclosure.

FIG. 21 is a schematic cross-sectional view illustrating an example of a cross-section of the passive electronic component illustrated in FIG. 20 taken along line segment c1-c2.

FIG. 22 is a schematic cross-sectional view illustrating an example of a cross-section of the passive electronic component illustrated in FIG. 20 taken along line segment d1-d2.

FIG. 23 is a schematic cross-sectional view illustrating an example of a cross-section of the passive electronic component illustrated in FIG. 20 taken along line segment e1-e2.

FIG. 24 is a schematic plan view illustrating an example of a passive electronic component according to embodiment 4 of the present disclosure.

FIG. 25 is a schematic cross-sectional view illustrating an example of a cross-section of the passive electronic component illustrated in FIG. 24 taken along line segment f1-f2.

FIG. 26 is a schematic cross-sectional view illustrating an example of a cross-section of the passive electronic component illustrated in FIG. 24 taken along line segment g1-g2.

### DESCRIPTION OF THE PREFERRED EMBODIMENTS

A passive electronic component according to the present disclosure will be described. It should be noted that the present disclosure is not limited to the structure described below and may be changed as appropriate without departing from the gist of the present disclosure. The present disclosure also includes combinations of individual preferred structures described below.

The embodiments illustrated below are examples and it will be appreciated that partial substitutions or combinations of the structures illustrated in different embodiments are possible. In embodiment 2 and subsequent embodiments, descriptions of matters common to embodiment 1 are omitted, and the differences are mainly described. In particular, the similar operations and effects of the similar structures will not be described one by one for each embodiment.

In the following description, when the individual embodiments are not specifically distinguished, the passive electronic component according to the present disclosure is used.

In the following description, an electronic component including a capacitor is used as an example of the passive electronic component according to the present disclosure. The passive electronic component according to the present disclosure may be a capacitor itself.

The diagrams illustrated below are schematic diagrams, and the dimensions, the scales of aspect ratios, and the like may differ from those of the actual product.

In this specification, unless otherwise specified, the terms (for example, parallel, orthogonal, and the like) indicating the relationship between elements and the terms indicating the shapes of elements do not only mean the strictly literal aspects but also encompass substantially equivalent ranges including ranges with differences of approximately a few percent.

The passive electronic component according to the present disclosure includes: a substrate having a first main surface and a second main surface that face away from each other in a first direction; and a plurality of capacitors on a first main surface side of the substrate, in which the plurality of capacitors include a first capacitor and a second capacitor spaced apart from the first capacitor in a second direction orthogonal to the first direction, the first capacitor includes a first capacitance forming portion that includes a first inner electrode layer, a first dielectric layer, and a second inner electrode layer that are laminated sequentially from a substrate side in the first direction, the second capacitor includes a second capacitance forming portion that includes a third inner electrode layer, a second dielectric layer, and a fourth inner electrode layer that are laminated sequentially from the substrate side in the first direction, and at least a portion of the second inner electrode layer and at least a portion of the third inner electrode layer are in contact with a surface of the first dielectric layer on an opposite side from the substrate.

### Embodiment 1

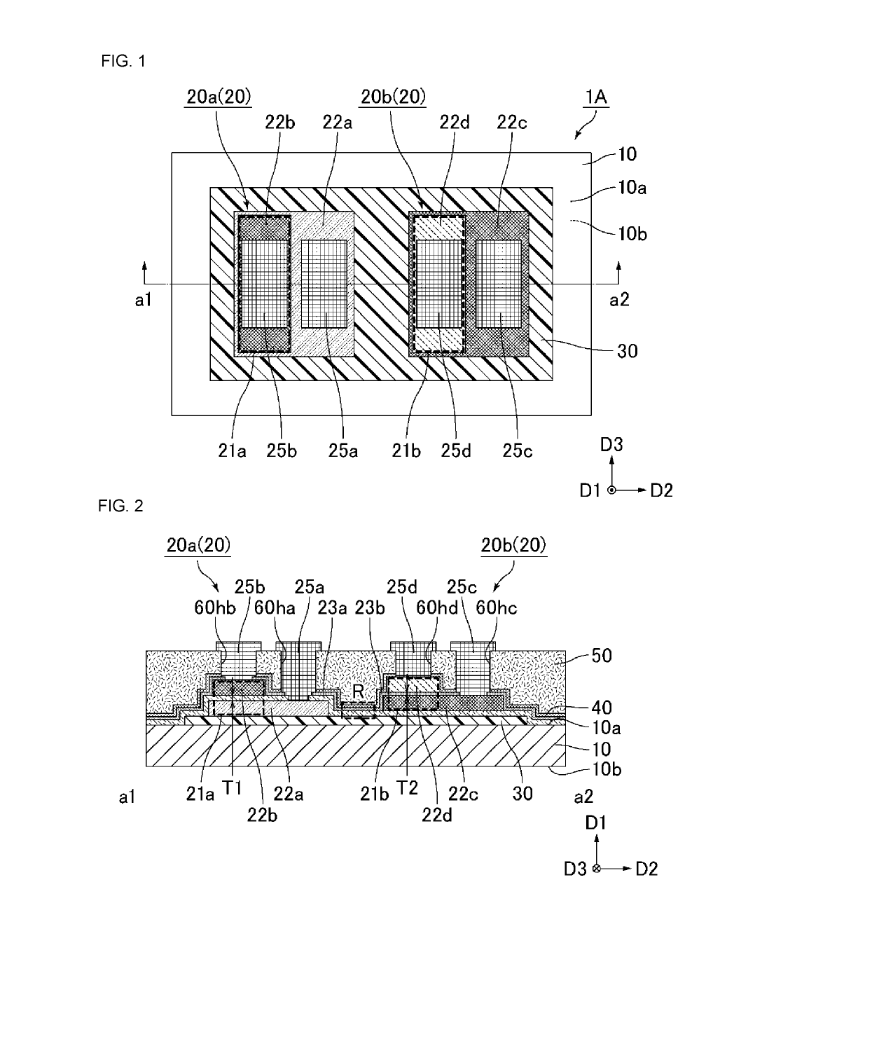

FIG. 1 is a schematic plan view illustrating an example of a passive electronic component according to embodiment 1 of the present disclosure. FIG. 2 is a schematic cross-sectional view illustrating an example of a cross-section of the passive electronic component illustrated in FIG. 1 taken along line segment a1-a2.

A passive electronic component 1A illustrated in FIGS. 1 and 2 includes a substrate 10 and a plurality of capacitors 20.

The substrate 10 has a first main surface 10a and a second main surface 10b that face away from each other in a first direction D1.

The substrate 10 is preferably a semiconductor substrate. In this case, the material of the substrate 10 may be, for example, a semiconductor material, such as silicon or gallium arsenide.

The substrate 10 may be an insulating substrate. In this case, the material of the substrate 10 may be, for example, an insulating material, such as glass or alumina.

The plurality of capacitors 20 are provided on a first main surface 10a side of the substrate 10.

The plurality of capacitors 20 include a first capacitor 20a and a second capacitor 20b.

The first capacitor 20a includes a first capacitance forming portion 21a.

The first capacitance forming portion 21a includes a first inner electrode layer 22a, a first dielectric layer 23a, and a second inner electrode layer 22b that are laminated sequentially from a substrate 10 side in the first direction D1. In the first capacitance forming portion 21a, the first inner electrode layer 22a and the second inner electrode layer 22b that are adjacent to each other in the first direction D1 and the first dielectric layer 23a sandwiched between the first inner electrode layer 22a and the second inner electrode layer 22b constitute one capacitor element with a MIM structure.

In the example illustrated in FIGS. 1 and 2, the whole of the second inner electrode layer 22b overlaps the first inner electrode layer 22a in the first direction D1 with the first dielectric layer 23a therebetween.

In the first capacitor 20a, the first inner electrode layer 22a may extend more greatly in a direction (for example, a second direction D2 or a third direction D3) orthogonal to the first direction D1 than does the second inner electrode layer 22b.

The second capacitor 20b is spaced apart from the first capacitor 20a in the second direction D2 orthogonal to the first direction D1.

In the example illustrated in FIG. 1, the second direction D2 is a direction, orthogonal to the first direction D1, that passes through a first outer electrode 25a, a second outer electrode 25b, a third outer electrode 25c, and a fourth outer electrode 25d, which will be described later. It should be noted that, in the example illustrated in FIG. 1, the third direction D3 corresponds to a direction that is orthogonal to the first direction D1 and also orthogonal to the second direction D2.

Accordingly, in the example illustrated in FIG. 1, the first direction D1, the second direction D2, and the third direction D3 are orthogonal to each other.

In the example illustrated in FIG. 1, the second direction D2 corresponds to the longitudinal direction of the passive electronic component 1A, and the third direction D3 corresponds to the transverse direction of the passive electronic component 1A. It should be noted that the second direction D2 may also correspond to the transverse direction of the passive electronic component 1A, and the third direction D3 may also correspond to the longitudinal direction of the passive electronic component 1A.

The second capacitor 20b includes a second capacitance forming portion 21b.

The second capacitance forming portion 21b includes a third inner electrode layer 22c, a second dielectric layer 23b, and a fourth inner electrode layer 22d that are laminated sequentially from the substrate 10 side in the first direction D1. In the second capacitance forming portion 21b, the third inner electrode layer 22c and the fourth inner electrode layer 22d that are adjacent to each other in the first direction D1 and the second dielectric layer 23b sandwiched between the third inner electrode layer 22c and the fourth inner electrode layer 22d constitute one capacitor element with a MIM structure.

In the second capacitor 20b, the third inner electrode layer 22c may extend more greatly in the direction (for example, the second direction D2 or the third direction D3) orthogonal to the first direction D1 than does the fourth inner electrode layer 22d.

The material of each of the inner electrode layers may be, for example, a conductive material, such as copper, silver, gold, aluminum, and platinum, or another metal or an alloy containing at least one of these metals.

The materials of the inner electrode layers may be the same as each other, different from each other, or partially different from each other.

The material of each of the dielectric layers may be, for example, a dielectric material, such as silicon dioxide, aluminum oxide, hafnium oxide, tantalum oxide, or another oxide or silicon nitride or another nitride.

The materials of the dielectric layers may be the same as each other, different from each other, or partially different from each other.

It should be noted that the dielectric layers described above are not illustrated in FIG. 1.

In the passive electronic component 1A, at least a portion of the second inner electrode layer 22b and at least a portion of the third inner electrode layer 22c are in contact with a surface of the first dielectric layer 23a on the opposite side from the substrate 10.

In the example illustrated in FIG. 2, the first dielectric layer 23a sandwiched between the first inner electrode layer 22a and the second inner electrode layer 22b extends continuously from the first capacitance forming portion 21a to the second capacitance forming portion 21b so as to be in contact with a surface of the third inner electrode layer 22c on the substrate 10 side. That is, in the example illustrated in FIG. 2, the first dielectric layer 23a in contact with a surface of the second inner electrode layer 22b on the substrate 10 side extends continuously from the first capacitance forming portion 21a to the second capacitance forming portion 21b so as to be in contact with the surface of the third inner electrode layer 22c on the substrate 10 side. As described above, in the example illustrated in FIG. 2, the whole of the second inner electrode layer 22b and the whole of the third inner electrode layer 22c are in contact with the surface of the first dielectric layer 23a on the opposite side from the substrate 10.

In the passive electronic component 1A, since at least a portion of the second inner electrode layer 22b and at least a portion of the third inner electrode layer 22c are in contact with the surface of the first dielectric layer 23a on the opposite side from the substrate 10, when the second capacitance forming portion 21b is formed, in particular, by sequentially laminating the second dielectric layer 23b and the fourth inner electrode layer 22d on the third inner electrode layer 22c in the process of manufacturing the passive electronic component 1A, impurity layers with great dielectric dissipation factors are not formed on the surfaces of the third inner electrode layer 22c and the second dielectric layer 23b on the opposite side from the substrate 10. Specifically, this will be described in an example of the method of manufacturing the passive electronic component 1A, which will be described later.

In the process of manufacturing the passive electronic component 1A, since impurity layers with great dielectric dissipation factors are not formed on the surfaces of the third inner electrode layer 22c and the second dielectric layer 23b on the opposite side from the substrate 10, the power loss in the second capacitor 20b (the second capacitance forming portion 21b) does not become large. Accordingly, the passive electronic component 1A can exhibit electrical performance with better high-frequency characteristics than, for example, the electronic component described in Patent Document 1 in spite of the structure including a plurality of capacitors (here, the first capacitor 20a and the second capacitor 20b).

In the passive electronic component 1A, since at least a portion of the second inner electrode layer 22b and at least a portion of the third inner electrode layer 22c are in contact with the surface of the first dielectric layer 23a on the opposite side from the substrate 10, when the height in the first direction D1 with respect to the first main surface 10a of the substrate 10 is defined, the first capacitance forming portion 21a and the second capacitance forming portion 21b are located at different heights from each other. For example, the surface of the first inner electrode layer 22a of the first capacitance forming portion 21a on the substrate 10 side and the surface of the third inner electrode layer 22c of the second capacitance forming portion 21b on the substrate 10 side are located at different heights from each other. As described above, since the first capacitance forming portion 21a and the second capacitance forming portion 21b are located at different heights from each other in the passive electronic component 1A, electric field coupling and magnetic field coupling are smaller than those when the first capacitance forming portion 21a and the second capacitance forming portion 21b are located at the same height, and accordingly, cross talk is more easily reduced.

The first dielectric layer 23a of the first capacitance forming portion 21a and the second dielectric layer 23b of the second capacitance forming portion 21b preferably have different dimensions in the first direction D1 from each other. In this case, the capacity (electrostatic capacity) of the first capacitor 20a and the capacity of the second capacitor 20b can be easily set independently.

A dimension T1 in the first direction D1 of the first dielectric layer 23a of the first capacitance forming portion 21a refers to the dimension in the first direction D1 of only the portion of the first dielectric layer 23a that constitutes the first capacitance forming portion 21a of the first capacitor 20a. Specifically, the dimension T1 in the first direction D1 of the first dielectric layer 23a of the first capacitance forming portion 21a refers to the dimension in the first direction D1 of the portion sandwiched between the first inner electrode layer 22a and the second inner electrode layer 22b of the first dielectric layer 23a.

A dimension T2 in the first direction D1 of the second dielectric layer 23b of the second capacitance forming portion 21b refers to the dimension in the first direction D1 of only the portion of the second dielectric layer 23b that constitutes the second capacitance forming portion 21b of the second capacitor 20b. Specifically, the dimension T2 in the first direction D1 of the second dielectric layer 23b of the second capacitance forming portion 21b refers to the dimension in the first direction D1 of the portion of the second dielectric layer 23b sandwiched between the third inner electrode layer 22c and the fourth inner electrode layer 22d.

In the example illustrated in FIG. 2, the dimension T1 in the first direction D1 of the first dielectric layer 23a of the first capacitance forming portion 21a is greater than the dimension T2 in the first direction D1 of the second dielectric layer 23b of the second capacitance forming portion 21b.

It should be noted that the dimension T1 in the first direction D1 of the first dielectric layer 23a of the first capacitance forming portion 21a may be smaller than the dimension T2 in the first direction D1 of the second dielectric layer 23b of the second capacitance forming portion 21b.

In addition, the dimension T1 in the first direction D1 of the first dielectric layer 23a of the first capacitance forming portion 21a may be the same as the dimension T2 in the first direction D1 of the second dielectric layer 23b of the second capacitance forming portion 21b.

The second dielectric layer 23b sandwiched between the third inner electrode layer 22c and the fourth inner electrode layer 22d preferably extends continuously from the second capacitance forming portion 21b to the first capacitance forming portion 21a so as to cover the second inner electrode layer 22b on the opposite side thereof from the substrate 10.

The first dielectric layer 23a and the second dielectric layer 23b may be laminated sequentially from the substrate 10 side in the first direction D1 in a region between the first capacitor 20a (the first capacitance forming portion 21a) and the second capacitor 20b (the second capacitance forming portion 21b) in the second direction D2. That is, the first dielectric layer 23a and the second dielectric layer 23b may be in contact with each other in the first direction D1 in the region between the first capacitance forming portion 21a and the second capacitance forming portion 21b in the second direction D2.

The first dielectric layer 23a and the second dielectric layer 23b do not need to be provided in a region R between the first capacitor 20a (the first capacitance forming portion 21a) and the second capacitor 20b (the second capacitance forming portion 21b) in the second direction D2. In this case, reduction in the Q value (quality factor) of the passive electronic component 1A due to an electric field passing through the dielectric layers provided in the first capacitor 20a and the second capacitor 20b is suppressed.

The first capacitor 20a preferably further includes the first outer electrode 25a connected to the first inner electrode layer 22a.

In the example illustrated in FIGS. 1 and 2, the first outer electrode 25a is connected to a portion of the first inner electrode layer 22a that does not overlap the second inner electrode layer 22b in the first direction D1.

The first capacitor 20a preferably further includes the second outer electrode 25b connected to the second inner electrode layer 22b.

In the example illustrated in FIGS. 1 and 2, the second outer electrode 25b is spaced apart from the first outer electrode 25a in the second direction D2.

In the example illustrated in FIGS. 1 and 2, the second outer electrode 25b is connected to a portion of the second inner electrode layer 22b that overlaps the first inner electrode layer 22a in the first direction D1.

When the first capacitor 20a includes the first outer electrode 25a and the second outer electrode 25b, the first capacitor 20a constitutes a two-terminal capacitor.

The second capacitor 20b preferably further includes the third outer electrode 25c connected to the third inner electrode layer 22c.

In the example illustrated in FIGS. 1 and 2, the third outer electrode 25c is connected to a portion of the third inner electrode layer 22c that does not overlap the fourth inner electrode layer 22d in the first direction D1.

The second capacitor 20b preferably further includes the fourth outer electrode 25d connected to the fourth inner electrode layer 22d.

In the example illustrated in FIGS. 1 and 2, the fourth outer electrode 25d is spaced apart from the third outer electrode 25c in the second direction D2.

In the examples illustrated in FIGS. 1 and 2, the fourth outer electrode 25d is connected to a portion of the fourth inner electrode layer 22d that overlaps the third inner electrode layer 22c in the first direction D1.

When the second capacitor 20b includes the third outer electrode 25c and the fourth outer electrode 25d, the second capacitor 20b constitutes a two-terminal capacitor.

When the first capacitor 20a includes the first outer electrode 25a and the second outer electrode 25b, and the second capacitor 20b includes the third outer electrode 25c and the fourth outer electrode 25d, the passive electronic component 1A can function independently.

The material of each of the outer electrodes may be, for example, a conductive material, such as copper, nickel, silver, gold, aluminum, palladium, titanium, tin, or another metal or an alloy containing at least one of these metals.

The materials of the outer electrode layers may be the same as each other, different from each other, or partially different from each other.

The outer electrodes may have a single-layer structure or a multilayer structure.

When the outer electrodes have a multilayer structure, the outer electrodes may each have a seed layer, a first plating layer, and a second plating layer laminated sequentially from the substrate 10 side.

The seed layer may be, for example, a multilayer body in which a conductor layer made of titanium and a conductor layer made of copper are laminated sequentially from the substrate 10 side.

The first plating layer may be, for example, a nickel plating layer or the like.

The second plating layer may be, for example, a gold plating layer, a tin plating layer, or the like.

The layer structures of the outer electrode layers may be the same as each other, different from each other, or partially different from each other.

The periphery of the second outer electrode 25b is preferably located inside the periphery of the second inner electrode layer 22b in plan view in the first direction D1. In this case, since the parasitic capacitance between the second outer electrode 25b and the first inner electrode layer 22a is minimized, the Q value of the passive electronic component 1A is likely to increase.

The periphery of the fourth outer electrode 25d is preferably located inside the periphery of the fourth inner electrode layer 22d in plan view in the first direction D1. In this case, since the parasitic capacitance between the fourth outer electrode 25d and the third inner electrode layer 22c is minimized, the Q value of the passive electronic component 1A is likely to increase.

The first outer electrode 25a preferably does not overlap the second inner electrode layer 22b in plan view in the first direction D1. In this case, since the parasitic capacitance between the first outer electrode 25a and the second inner electrode layer 22b is minimized, the Q value of the passive electronic component 1A is likely to increase.

The third outer electrode 25c preferably does not overlap the fourth inner electrode layer 22d in plan view in the first direction D1. In this case, since the parasitic capacitance between the third outer electrode 25c and the fourth inner electrode layer 22d is minimized, the Q value of the passive electronic component 1A is likely to increase.

The passive electronic component 1A preferably further includes an insulating layer 30 provided between the substrate 10 and the first capacitor 20a in the first direction D1 and between the substrate 10 and the second capacitor 20b in the first direction D1.

In the example illustrated in FIGS. 1 and 2, the insulating layer 30 extends continuously between the substrate 10 and the first capacitor 20a in the first direction D1 and between the substrate 10 and the second capacitor 20b in the first direction D1.

The insulating layer 30 is preferably in contact with the substrate 10 in the first direction D1.

The insulating layer 30 is preferably in contact with the first capacitor 20a in the first direction D1.

The insulating layer 30 is preferably in contact with the second capacitor 20b in the first direction D1.

The insulating layer 30 may be provided so as to cover the whole of the first main surface 10a of the substrate 10 or may be provided so as to cover a portion of the first main surface 10a of the substrate 10.

If the insulating layer 30 is provided when the substrate 10 is a semiconductor substrate, since the parasitic capacitance between the substrate 10 and the first capacitor 20a and the parasitic capacitance between the substrate 10 and the second capacitor 20b are reduced, the Q value of the passive electronic component 1A increases.

It should be noted that, when the substrate 10 is an insulating substrate, the insulating layer 30 does not need to be provided. When the insulating layer 30 is not provided, the substrate 10 and the first capacitor 20a are preferably in contact with each other in the first direction D1, and the substrate 10 and the second capacitor 20b are preferably in contact with each other in the first direction D1.

The periphery of the insulating layer 30 is preferably located outside the peripheries of all the inner electrode layers included in the first capacitor 20a and the second capacitor 20b in plan view in the first direction D1.

The material of the insulating layer 30 may be, for example, an insulating material, such as silicon dioxide, aluminum oxide, or another oxide or silicon nitride or another nitride.

The passive electronic component 1A preferably further includes a moisture-resistant protective layer 40 that covers the first capacitance forming portion 21a and the second capacitance forming portion 21b. In this case, the moisture resistance of the first capacitance forming portion 21a and the second capacitance forming portion 21b is increased. Specifically, the moisture-resistant protective layer 40 suppresses intrusion of moisture into the inner electrode layers of the first capacitance forming portion 21a and the second capacitance forming portion 21b, thereby suppressing the corrosion of the inner electrode layers.

The moisture-resistant protective layer 40 preferably covers the whole of the inner electrode layers and the dielectric layers of the first capacitor 20a from which the region containing the first outer electrode 25a and the second outer electrode 25b has been excluded.

The moisture-resistant protective layer 40 preferably covers the whole of the inner electrode layers and the dielectric layers of the second capacitor 20b from which the region containing the third outer electrode 25c and the fourth outer electrode 25d has been excluded.

The material of the moisture-resistant protective layer 40 may be, for example, a moisture-resistant material, such as silicon dioxide or another dioxide or silicon nitride or another nitride.

It should be noted that the moisture-resistant protective layer 40 is not illustrated in FIG. 1.

The passive electronic component 1A preferably further includes a resin protective layer 50 that covers the substrate 10, the first capacitance forming portion 21a, and the second capacitance forming portion 21b. In this case, the substrate 10, the first capacitance forming portion 21a, and the second capacitance forming portion 21b are protected from moisture.

The resin protective layer 50 preferably covers the whole of the inner electrode layers and the dielectric layers of the first capacitor 20a from which the region containing the first outer electrode 25a and the second outer electrode 25b has been excluded.

The resin protective layer 50 preferably covers the whole of the inner electrode layers and the dielectric layers of the second capacitor 20b from which the region containing the third outer electrode 25c and the fourth outer electrode 25d has been excluded.

The material of the resin protective layer 50 may be, for example, a resin material, such as polyimide resin or a resin in a solder resist.

It should be noted that the resin protective layer 50 is not illustrated in FIG. 1.

When the passive electronic component 1A includes the moisture-resistant protective layer 40 and the resin protective layer 50, the resin protective layer 50 preferably covers the whole of the moisture-resistant protective layer 40.

When the passive electronic component 1A includes the moisture-resistant protective layer 40 and the resin protective layer 50, the first outer electrode 25a is preferably provided in a through-hole 60ha that passes through at least the moisture-resistant protective layer 40 and the resin protective layer 50 in the first direction D1. That is, the first outer electrode 25a is preferably connected to the first inner electrode layer 22a via the through-hole 60ha.

When the passive electronic component 1A includes the moisture-resistant protective layer 40 and the resin protective layer 50, the second outer electrode 25b is preferably provided in a through-hole 60hb that passes through at least the moisture-resistant protective layer 40 and the resin protective layer 50 in the first direction D1. That is, the second outer electrode 25b is preferably connected to the second inner electrode layer 22b via the through-hole 60hb.

When the passive electronic component 1A includes the moisture-resistant protective layer 40 and the resin protective layer 50, the third outer electrode 25c is preferably provided in a through-hole 60hc that passes through at least the moisture-resistant protective layer 40 and the resin protective layer 50 in the first direction D1. That is, the third outer electrode 25c is preferably connected to the third inner electrode layer 22c via the through-hole 60hc.

When the passive electronic component 1A includes the moisture-resistant protective layer 40 and the resin protective layer 50, the fourth outer electrode 25d is preferably provided in a through-hole 60hd that passes through at least the moisture-resistant protective layer 40 and the resin protective layer 50 in the first direction D1. That is, the fourth outer electrode 25d is preferably connected to the fourth inner electrode layer 22d via the through-hole 60hd.

The passive electronic component 1A is manufactured, for example, by the following method.

### Process of preparing substrate

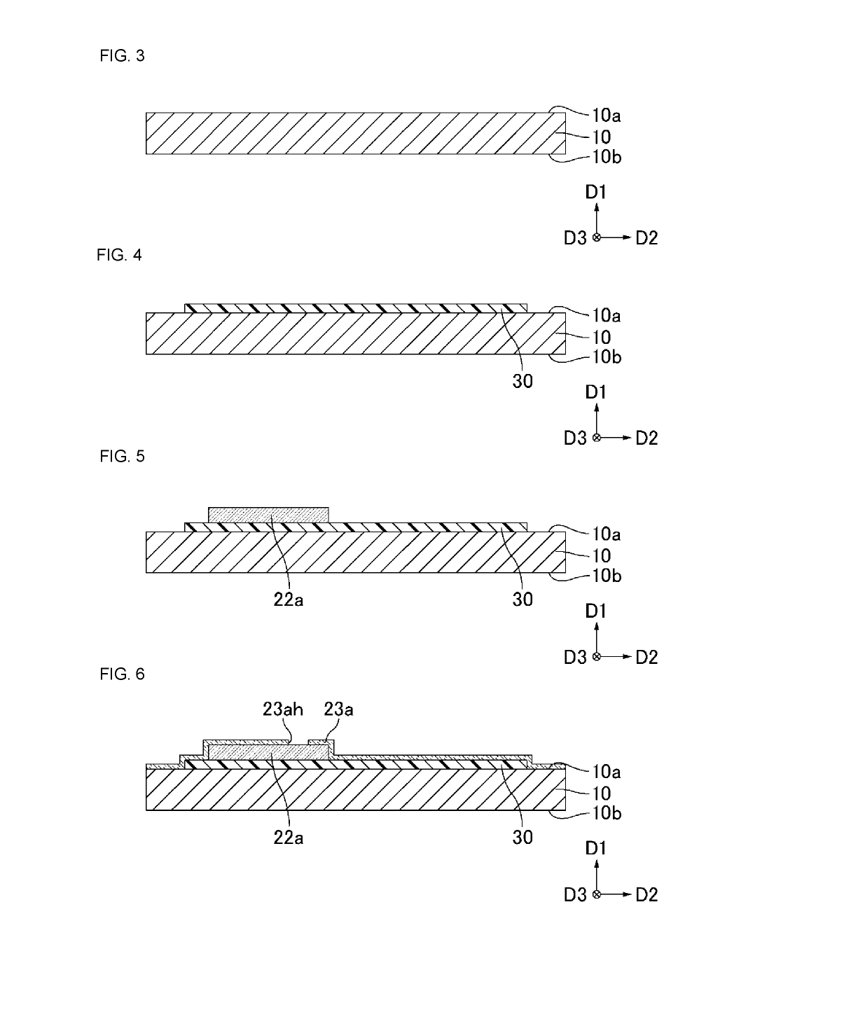

FIG. 3 is a schematic cross-sectional view illustrating a process of preparing a substrate in an example of a method of manufacturing the passive electronic component according to embodiment 1 of the present disclosure.

The substrate 10 is prepared as illustrated in FIG. 3.

### Process of forming insulating layer

FIG. 4 is a schematic cross-sectional view illustrating a process of forming an insulating layer in the example of the method of manufacturing the passive electronic component according to embodiment 1 of the present disclosure.

The insulating layer made of an insulating material is formed on the first main surface 10a of the substrate 10 by using a chemical vapor deposition (CVD) method, a physical vapor deposition (PVD) method, or the like. After that, patterning of the insulating layer is performed by combining a photolithographic method with an etching method, thereby forming the insulating layer 30 as illustrated in FIG. 4.

### Process of forming first inner electrode layer

FIG. 5 is a schematic cross-sectional view illustrating a process of forming the first inner electrode layer in the example of the method of manufacturing the passive electronic component according to embodiment 1 of the present disclosure.

An electrode layer made of a conductive material is formed by using a CVD method, a PVD method, or the like so as to cover the structure illustrated in FIG. 4 from the first main surface 10a side of the substrate 10. After that, patterning of the electrode layer is performed by combining a photolithographic method with an etching method, thereby forming the first inner electrode layer 22a as illustrated in FIG. 5.

### Process of forming first dielectric layer

FIG. 6 is a schematic cross-sectional view illustrating a process of forming the first dielectric layer in the example of the method of manufacturing the passive electronic component according to embodiment 1 of the present disclosure.

A dielectric layer made of a dielectric material is formed by using a CVD method, a PVD method, or the like so as to cover the structure illustrated in FIG. 5 from the first main surface 10a side of the substrate 10. After that, patterning of the dielectric layer is performed by combining a photolithographic method with an etching method, thereby forming the first dielectric layer 23a as illustrated in FIG. 6. Specifically, the first dielectric layer 23a is formed so as to cover the substrate 10, the first inner electrode layer 22a, and the insulating layer 30 from the first main surface 10a side of the substrate 10. At this time, a through-hole 23ah that passes through the first dielectric layer 23a in the first direction D1 is provided such that a portion of the first inner electrode layer 22a is exposed.

In the process, when the first dielectric layer 23a is formed on the first inner electrode layer 22a, processing that, for example, removes the dielectric layer by patterning is not performed on a region of the first inner electrode layer 22a in which the first capacitance forming portion 21a is formed later. As a result, in the process, when the first dielectric layer 23a is formed on the first inner electrode layer 22a, an impurity layer with great dielectric dissipation factor is not formed on the surface of the first inner electrode layer 22a, on the opposite side from the substrate 10, that constitutes the first capacitance forming portion 21a later.

### Process of forming second inner electrode layer and third inner electrode layer

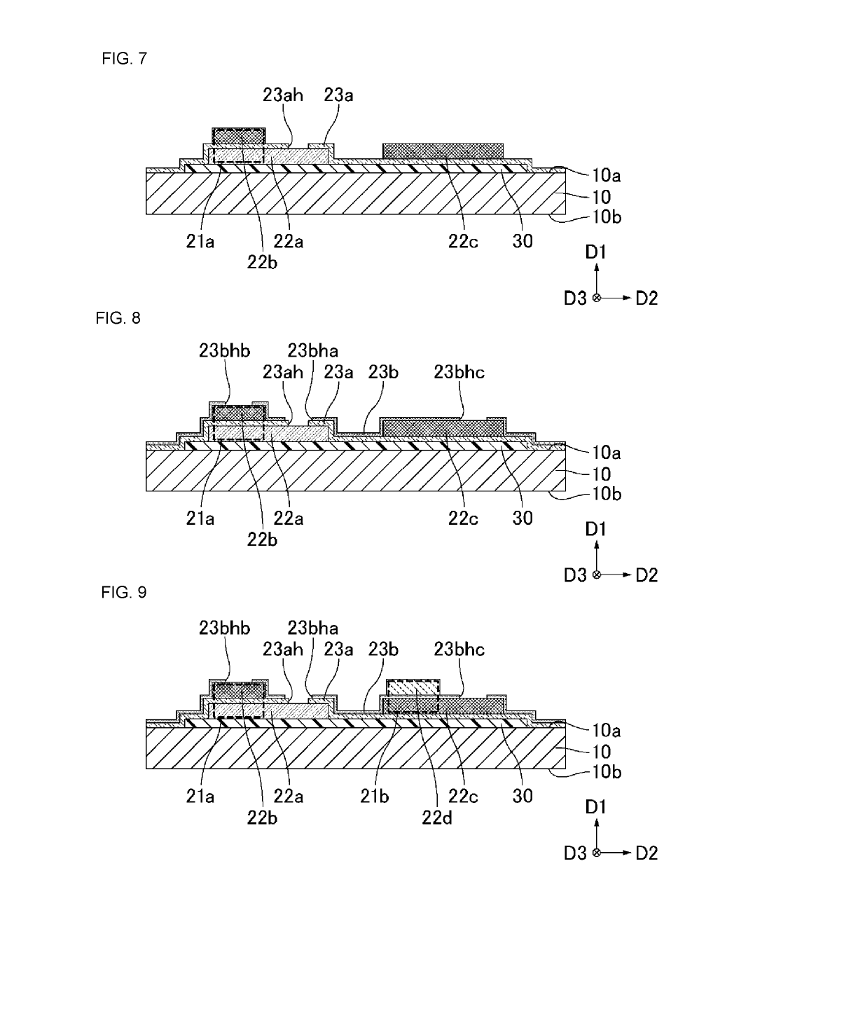

FIG. 7 is a schematic cross-sectional view illustrating a process of forming the second inner electrode layer and the third inner electrode layer in the example of the method of manufacturing the passive electronic component according to embodiment 1 of the present disclosure.

An electrode layer made of a conductive material is formed by using a CVD method, a PVD method, or the like so as to cover the structure illustrated in FIG. 6 from the first main surface 10a side of the substrate 10. After that, patterning of the electrode layer is performed by combining a photolithographic method with an etching method, thereby forming the second inner electrode layer 22b and the third inner electrode layer 22c as illustrated in FIG. 7. Specifically, the second inner electrode layer 22b is formed at a position adjacent to the first inner electrode layer 22a with the first dielectric layer 23a therebetween in the first direction D1, and the third inner electrode layer 22c is formed at a position not adjacent to the first inner electrode layer 22a with the first dielectric layer 23a therebetween in the first direction D1. As a result, at least a portion (the whole of the second inner electrode layer 22b in the example illustrated in FIG. 7) of the second inner electrode layer 22b and at least a portion (the whole of the third inner electrode layer 22c in the example illustrated in FIG. 7) of the third inner electrode layer 22c are in contact with the surface of the first dielectric layer 23a on the opposite side from the substrate 10.

In the process, when the second inner electrode layer 22b is formed on the first dielectric layer 23a, processing that, for example, removes the electrode layer by patterning is not performed on a region (a region of the first dielectric layer 23a in which the second inner electrode layer 22b is formed) of the first dielectric layer 23a in which the first capacitance forming portion 21a is formed later. As a result, in the process, when the second inner electrode layer 22b is formed on the first dielectric layer 23a, an impurity layer with great dielectric dissipation factor is not formed on the surface of the first dielectric layer 23a, on the opposite side from the substrate 10, that constitutes the first capacitance forming portion 21a later.

In the process, the second inner electrode layer 22b and the third inner electrode layer 22c are preferably formed on the first dielectric layer 23a at the same timing. It should be noted that, in the process, the second inner electrode layer 22b and the third inner electrode layer 22c may be formed on the first dielectric layer 23a at different timings.

The process described above forms the first capacitance forming portion 21a in which the first inner electrode layer 22a, the first dielectric layer 23a, and the second inner electrode layer 22b are laminated sequentially from the substrate 10 side in the first direction D1.

### Process of forming second dielectric layer

FIG. 8 is a schematic cross-sectional view illustrating a process of forming the second dielectric layer in the example of the method of manufacturing the passive electronic component according to embodiment 1 of the present disclosure.

A dielectric layer made of a dielectric material is formed by using a CVD method, a PVD method, or the like so as to cover the structure illustrated in FIG. 7 from the first main surface 10a side of the substrate 10. After that, patterning of the dielectric layer is performed by combining a photolithographic method with an etching method, thereby forming the second dielectric layer 23b as illustrated in FIG. 8. Specifically, the second dielectric layer 23b is formed so as to cover the second inner electrode layer 22b, the third inner electrode layer 22c, and the first dielectric layer 23a from the first main surface 10a side of the substrate 10. At this time, a through-hole 23bha that passes through the second dielectric layer 23b in the first direction D1 is provided at a position that overlaps the through-hole 23ah in the first direction D1 such that a portion of the first inner electrode layer 22a is exposed. In addition, a through-hole 23bhb that passes through the second dielectric layer 23b in the first direction D1 is provided such that a portion of the second inner electrode layer 22b is exposed. In addition, a through-hole 23bhc that passes through the second dielectric layer 23b in the first direction D1 is provided such that a portion of the third inner electrode layer 22c is exposed.

In the process, when the second dielectric layer 23b is formed on the third inner electrode layer 22c, processing that, for example, removes the dielectric layer by patterning is not performed on a region of the third inner electrode layer 22c in which the second capacitance forming portion 21b is formed later. As a result, in the process, when the second dielectric layer 23b is formed on the third inner electrode layer 22c, an impurity layer with great dielectric dissipation factor is not formed on the surface of the third inner electrode layer 22c, on the opposite side from the substrate 10, that constitutes the second capacitance forming portion 21b later.

### Process of forming fourth inner electrode layer

FIG. 9 is a schematic cross-sectional view illustrating a process of forming the fourth inner electrode layer in the example of the method of manufacturing the passive electronic component according to embodiment 1 of the present disclosure.

An electrode layer made of a conductive material is formed by using a CVD method, a PVD method, or the like so as to cover the structure illustrated in FIG. 8 from the first main surface 10a side of the substrate 10. After that, patterning of the electrode layer is performed by combining a photolithographic method with an etching method, thereby forming the fourth inner electrode layer 22d as illustrated in FIG. 9. Specifically, the fourth inner electrode layer 22d is formed at a position adjacent to the third inner electrode layer 22c with the second dielectric layer 23b therebetween in the first direction D1.

In the process, when the fourth inner electrode layer 22d is formed on the second dielectric layer 23b, processing that, for example, removes the electrode layer by patterning is not performed on a region (a region of the second dielectric layer 23b in which the fourth inner electrode layer 22d is formed) of the second dielectric layer 23b in which the second capacitance forming portion 21b is formed later. As a result, in the process, when the fourth inner electrode layer 22d is formed on the second dielectric layer 23b, an impurity layer with great dielectric dissipation factor is not formed on the surface of the second dielectric layer 23b, on the opposite side from the substrate 10, that constitutes the second capacitance forming portion 21b later.

The process described above forms the second capacitance forming portion 21b in which the third inner electrode layer 22c, the second dielectric layer 23b, and the fourth inner electrode layer 22d are laminated sequentially from the substrate 10 side in the first direction D1.

In the process described above, when the first capacitance forming portion 21a is formed by sequentially laminating the first dielectric layer 23a and the second inner electrode layer 22b on the first inner electrode layer 22a, an impurity layer with great dielectric dissipation factor is not formed on the surfaces of the first inner electrode layer 22a and the first dielectric layer 23a on the opposite side from the substrate 10. As a result, in the passive electronic component 1A to be obtained later, the power loss in the first capacitor 20a (the first capacitance forming portion 21a) does not become large.

In addition, in the process described above, when the second capacitance forming portion 21b is formed by sequentially laminating the second dielectric layer 23b and the fourth inner electrode layer 22d on the third inner electrode layer 22c, an impurity layer with great dielectric dissipation factor is not formed on the surfaces of the third inner electrode layer 22c and the second dielectric layer 23b on the opposite side from the substrate 10. As a result, in the passive electronic component 1A to be obtained later, the power loss in the second capacitor 20b (the second capacitance forming portion 21b) does not become large.

As a result, the passive electronic component 1A to be obtained later can exhibit electrical performance with better high-frequency characteristics in the structure including a plurality of capacitors (here, the first capacitor 20a and the second capacitor 20b).

### Process of forming moisture-resistant protective layer

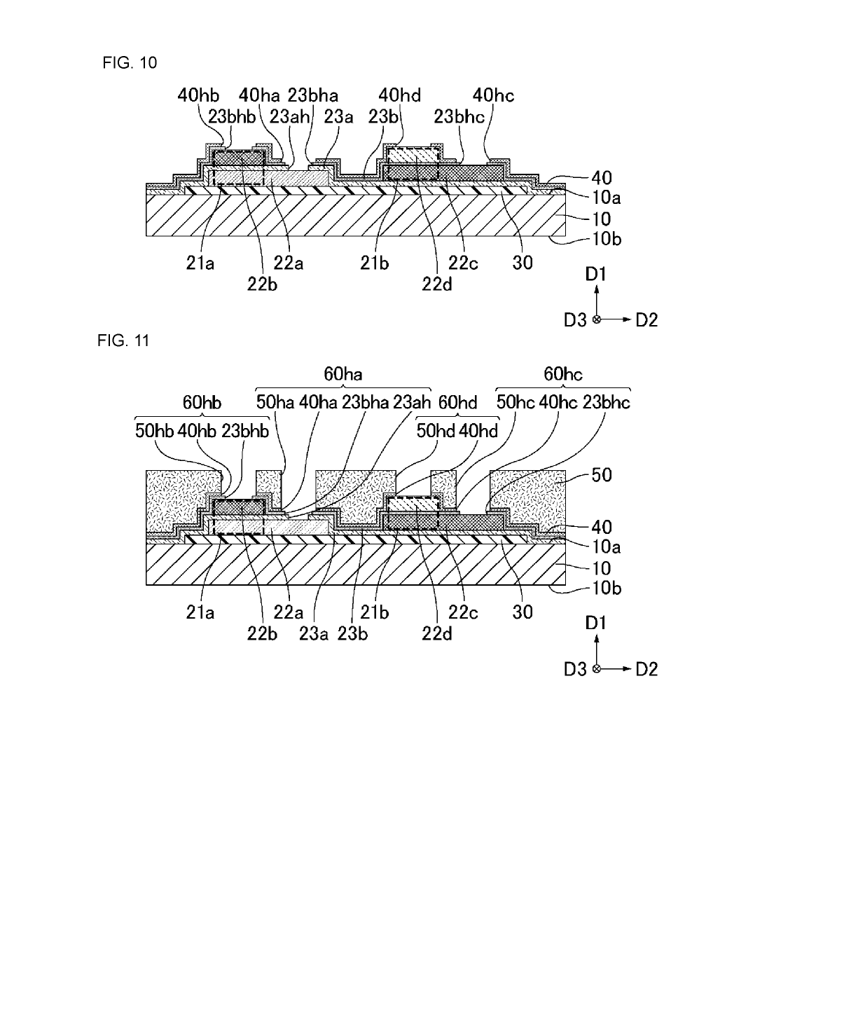

FIG. 10 is a schematic cross-sectional view illustrating a process of forming the moisture-resistant protective layer in the example of the method of manufacturing the passive electronic component according to embodiment 1 of the present disclosure.

A moisture-resistant layer made of a moisture-resistant material is formed by using a CVD method, a PVD method, or the like so as to cover the structure illustrated in FIG. 9 from the first main surface 10a side of the substrate 10. After that, patterning of the moisture-resistant layer is performed by combining a photolithographic method with an etching method, thereby forming the moisture-resistant protective layer 40 as illustrated in FIG. 10. Specifically, the moisture-resistant protective layer 40 is formed so as to cover the fourth inner electrode layer 22d and the second dielectric layer 23b from the first main surface 10a side of the substrate 10. At this time, a through-hole 40ha that passes through the moisture-resistant protective layer 40 in the first direction D1 is provided at a position that overlaps the through-hole 23ah and the through-hole 23bha in the first direction D1 such that a portion of the first inner electrode layer 22a is exposed. In addition, a through-hole 40hb that passes through the moisture-resistant protective layer 40 in the first direction D1 is provided at a position that overlaps the through-hole 23bhb in the first direction D1 such that a portion of the second inner electrode layer 22b is exposed. In addition, a through-hole 40hc that passes through the moisture-resistant protective layer 40 in the first direction D1 is provided at a position that overlaps the through-hole 23bhc in the first direction D1 such that a portion of the third inner electrode layer 22c is exposed. In addition, a through-hole 40hd that passes through the moisture-resistant protective layer 40 in the first direction D1 is provided such that a portion of the fourth inner electrode layer 22d is exposed.

### Process of forming resin protective layer

FIG. 11 is a schematic cross-sectional view illustrating a process of forming the resin protective layer in the example of the method of manufacturing the passive electronic component according to embodiment 1 of the present disclosure.

A resin layer made of a resin material is formed by a spin coating method or the like so as to cover the structure illustrated in FIG. 10 from the first main surface 10a side of the substrate 10. After that, patterning of the resin layer is performed by using only a photolithographic method when the resin material of the resin layer is photosensitive or by combining a photolithographic method with an etching method when the resin material of the resin layer is non-photosensitive, thereby forming the resin protective layer 50 as illustrated in FIG. 11. Specifically, the resin protective layer 50 is formed so as to cover the moisture-resistant protective layer 40 from the first main surface 10a side of the substrate 10. At this time, a through-hole 50ha that passes through the resin protective layer 50 in the first direction D1 is provided at a position that overlaps the through-hole 23ah, the through-hole 23bha, and the through-hole 40ha in the first direction D1 such that a portion of the first inner electrode layer 22a is exposed. In addition, a through-hole 50hb that passes through the resin protective layer 50 in the first direction D1 is provided at a position that overlaps the through-hole 23bhb and the through-hole 40hb in the first direction D1 such that a portion of the second inner electrode layer 22b is exposed. In addition, a through-hole 50hc that passes through the resin protective layer 50 in the first direction D1 is provided at a position that overlaps the through-hole 23bhc and the through-hole 40hc in the first direction D1 such that a portion of the third inner electrode layer 22c is exposed. In addition, a through-hole 50hd that passes through the resin protective layer 50 in the first direction D1 is provided at a position that overlaps the through-hole 40hd in the first direction D1 such that a portion of the fourth inner electrode layer 22d is exposed.

The process described above forms the through-hole 60ha including the through-hole 23ah, the through-hole 23bha, the through-hole 40ha, and the through-hole 50ha that communicate with each other in the first direction D1 such that a portion of the first inner electrode layer 22a is exposed. In addition, a through-hole 60hb including the through-hole 23bhb, the through-hole 40hb, and the through-hole 50hb that communicate with each other in the first direction D1 is formed such that a portion of the second inner electrode layer 22b is exposed. In addition, a through-hole 60hc including the through-hole 23bhc, the through-hole 40hc, and the through-hole 50hc that communicate with each other in the first direction D1 is formed such that a portion of the third inner electrode layer 22c is exposed. In addition, a through-hole 60hd including the through-hole 40hd and the through-hole 50hd that communicate with each other in the first direction D1 is formed such that a portion of the fourth inner electrode layer 22d is exposed.

### Process of forming first outer electrode, second outer electrode, third outer electrode, and fourth outer electrode

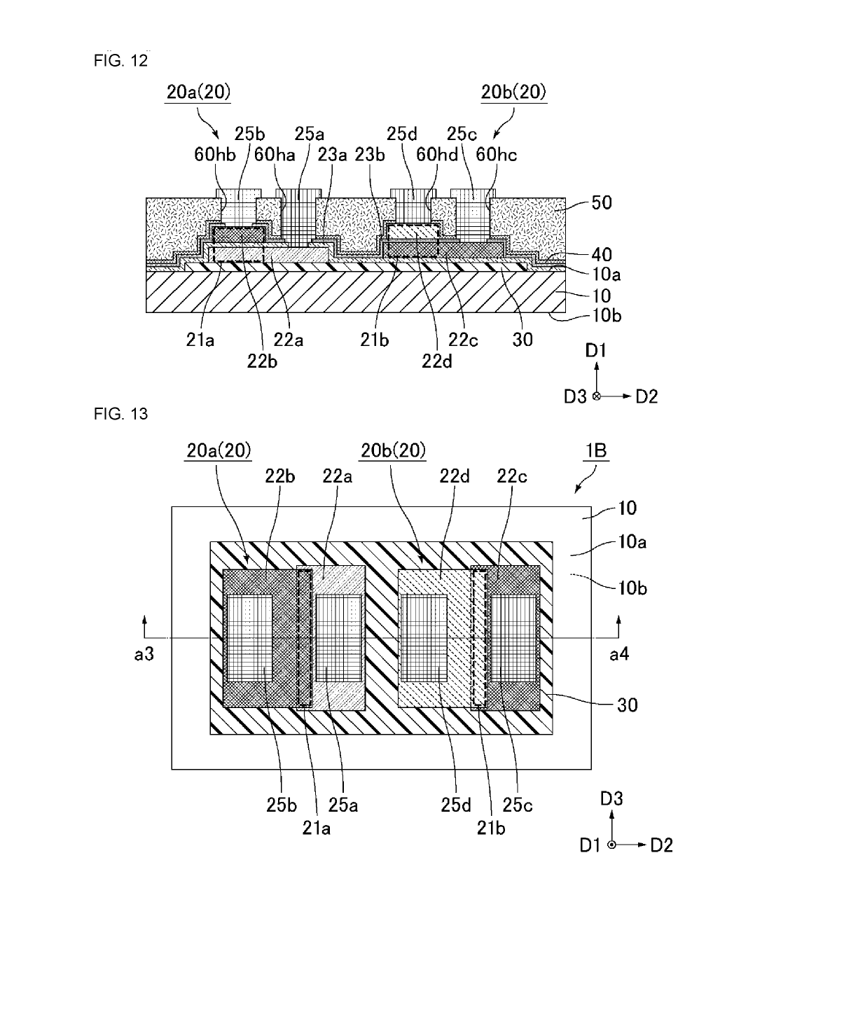

FIG. 12 is a schematic cross-sectional view illustrating a process of forming the first outer electrode, the second outer electrode, the third outer electrode, and the fourth outer electrode in the example of the method of manufacturing the passive electronic component according to embodiment 1 of the present disclosure.

As illustrated in FIG. 12, the first outer electrode 25a is formed in the through-hole 60ha, the second outer electrode 25b is formed in the through-hole 60hb, the third outer electrode 25c is formed in the through-hole 60hc, and the fourth outer electrode 25d is formed in the through-hole 60hd by using a plating method, an etching method, or the like. As a result, the first outer electrode 25a is connected to the first inner electrode layer 22a via the through-hole 60ha, the second outer electrode 25b is connected to the second inner electrode layer 22b via the through-hole 60hb, the third outer electrode 25c is connected to the third inner electrode layer 22c via the through-hole 60hc, and the fourth outer electrode 25d is connected to the fourth inner electrode layer 22d via the through-hole 60hd.

The process described above forms the first capacitor 20a including the first capacitance forming portion 21a, the first outer electrode 25a, and the second outer electrode 25b. In addition, the process forms the second capacitor 20b including the second capacitance forming portion 21b, the third outer electrode 25c, and the fourth outer electrode 25d.

As described above, the passive electronic component 1A is manufactured.

In the passive electronic component according to embodiment 1 of the present disclosure, the shapes of the inner electrode layers and the positions of the outer electrodes may differ from those in the example illustrated in the FIGS. 1 and 2.

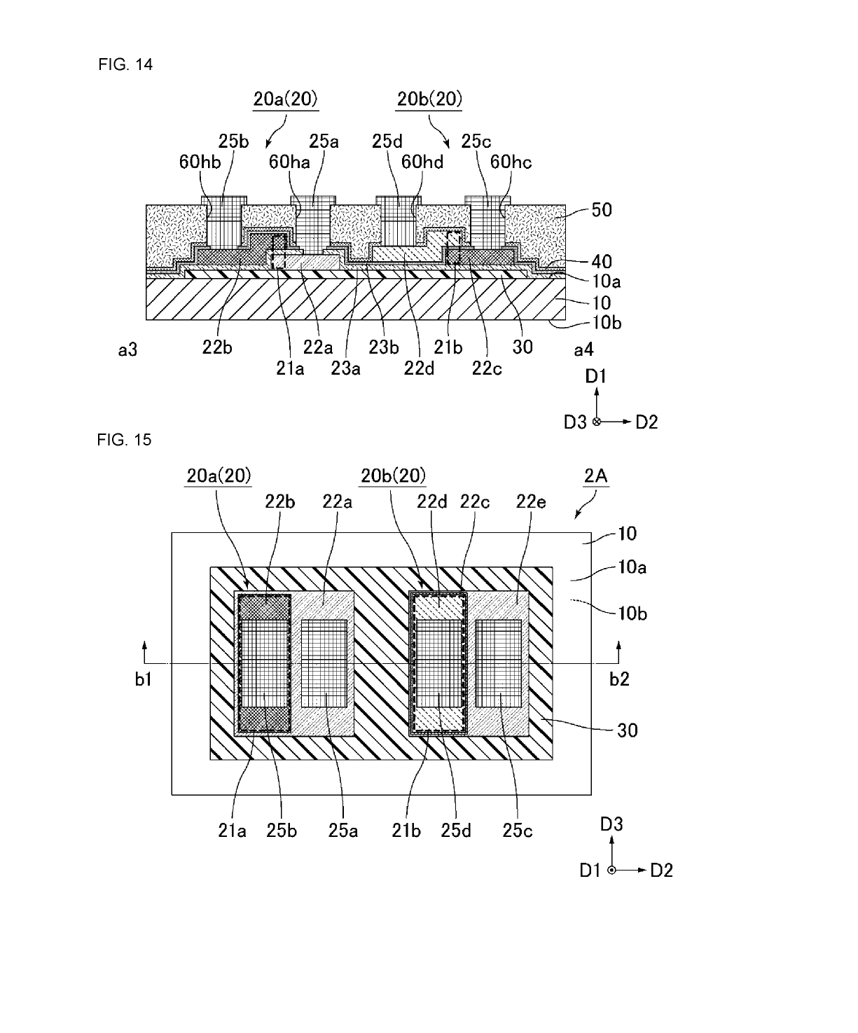

FIG. 13 is a schematic plan view illustrating another example of the passive electronic component according to embodiment 1 of the present disclosure. FIG. 14 is a schematic cross-sectional view illustrating an example of a cross-section of the passive electronic component illustrated in FIG. 13 taken along line segment a3-a4.

In a passive electronic component 1B illustrated in FIGS. 13 and 14, a portion of the second inner electrode layer 22b overlaps the first inner electrode layer 22a in the first direction D1 with the first dielectric layer 23a therebetween.

In the example illustrated in FIG. 14, a step is provided on a surface of the second inner electrode layer 22b on the substrate 10 side. In addition, in the example illustrated in FIG. 14, a step is provided on the surface of the second inner electrode layer 22b on the opposite side from the substrate 10. That is, in the example illustrated in FIG. 14, when the height in the first direction D1 with respect to the first main surface 10a of the substrate 10 is defined, the second inner electrode layer 22b is bent such that a portion on one end side in the second direction D2 has a different height from a portion on the other end side in the second direction D2.

In the passive electronic component 1B, a portion of the fourth inner electrode layer 22d overlaps the third inner electrode layer 22c in the first direction D1 with the second dielectric layer 23b therebetween.

In the example illustrated in FIG. 14, a step is provided on a surface of the fourth inner electrode layer 22d on the substrate 10 side. In addition, in the example illustrated in FIG. 14, a step is provided on the surface of the fourth inner electrode layer 22d on the opposite side from the substrate 10. That is, in the example illustrated in FIG. 14, when the height in the first direction D1 with respect to the first main surface 10a of the substrate 10 is defined, the fourth inner electrode layer 22d is bent such that a portion on one end side in the second direction D2 has a different height from a portion on the other end side in the second direction D2.

In the passive electronic component 1B, the second outer electrode 25b is connected to a portion of the second inner electrode layer 22b that does not overlap the first inner electrode layer 22a in the first direction D1.

In the passive electronic component 1B, the fourth outer electrode 25d is connected to a portion of the fourth inner electrode layer 22d that does not overlap the third inner electrode layer 22c in the first direction D1.

### Embodiment 2

In the passive electronic component according to embodiment 2 of the present disclosure, unlike the passive electronic component according to embodiment 1 of the present disclosure, the second capacitance forming portion further includes the first dielectric layer and the fifth inner electrode layer that are laminated sequentially on the substrate side of the third inner electrode layer in the first direction.

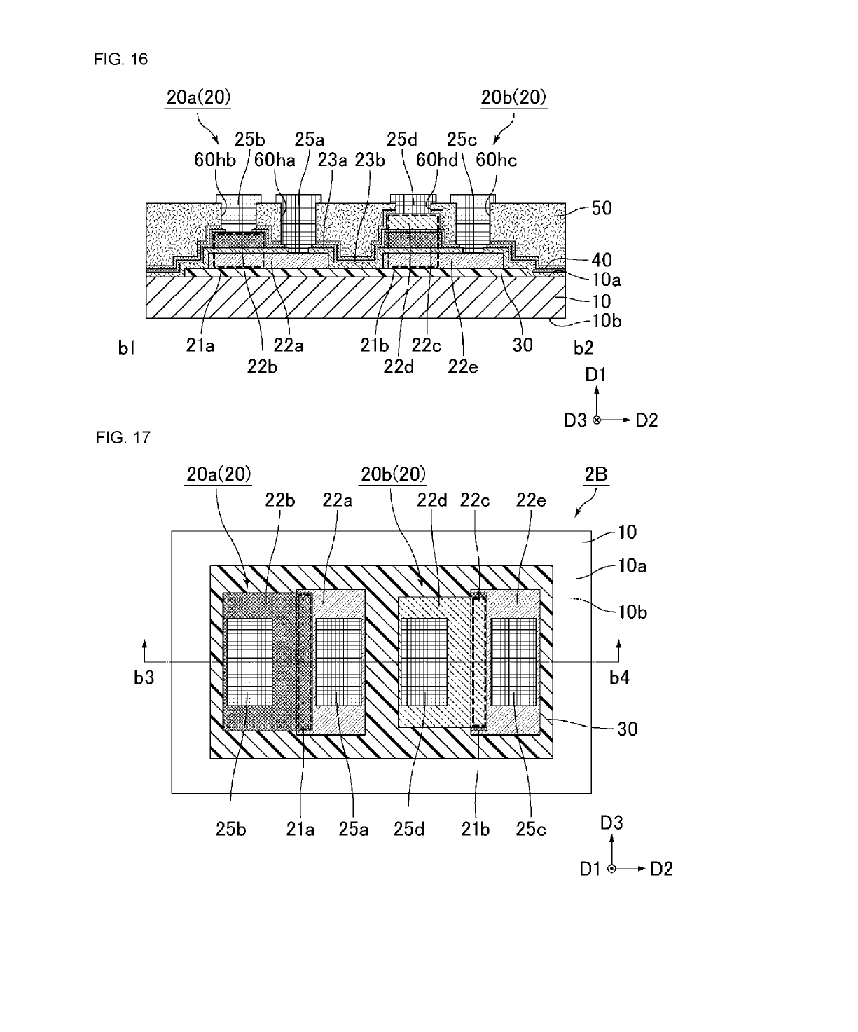

FIG. 15 is a schematic plan view illustrating an example of the passive electronic component according to embodiment 2 of the present disclosure. FIG. 16 is a schematic cross-sectional view illustrating an example of a cross-section of the passive electronic component illustrated in FIG. 15 taken along line segment b1-b2.

In a passive electronic component 2A illustrated in FIGS. 15 and 16, the second capacitance forming portion 21b further includes the first dielectric layer 23a and a fifth inner electrode layer 22e that are laminated sequentially on the substrate 10 side of the third inner electrode layer 22c in the first direction D1. As a result, in the second capacitance forming portion 21b, a capacitor element including the third inner electrode layer 22c, the second dielectric layer 23b, and the fourth inner electrode layer 22d a capacitor element including the third inner electrode layer 22c, the first dielectric layer 23a, and the fifth inner electrode layer 22e are connected in series to each other.

Since the second capacitance forming portion 21b of the passive electronic component 2A has a structure in which the capacitor element including the first dielectric layer 23a and the capacitor element including the second dielectric layer 23b are connected in series to each other, it is possible to achieve a capacitance equivalent to that of a capacitor element including, as a dielectric layer, a multilayer body including the first dielectric layer 23a and the second dielectric layer 23b.

Since the second capacitance forming portion 21b of the passive electronic component 2A has a structure in which the two capacitor elements described above are connected in series to each other, the electric field leaking from the end portions (for example, the end portions in the second direction D2) of the inner electrode layers is reduced. As a result, in the second capacitance forming portion 21b of the passive electronic component 2A, not only is the parasitic capacitance between the inner electrode layers reduced, but reduction in the Q value due to the parasitic capacitance is also suppressed.

Since the second capacitance forming portion 21b of the passive electronic component 2A has a structure in which the two capacitor elements described above are connected in series to each other, the capacity deviation is smaller than structure including only one capacitor element. In the capacitance forming portion, the greater the number of capacitor elements connected in series to each other, the smaller the capacity deviation.

In the second capacitance forming portion 21b of the passive electronic component 2A, since the two capacitor elements described above are connected in series to each other in the first direction D1, the second capacitor 20b, and thus the passive electronic component 2A, can be made smaller than a case in which the two capacitor elements are connected in series to each other in a direction orthogonal to the first direction D1, for example, in the second direction D2.

In the second capacitor 20b of the passive electronic component 2A, the fifth inner electrode layer 22e may extend more greatly in the direction (for example, the second direction D2 or the third direction D3) orthogonal to the first direction D1 than the third inner electrode layer 22c and the fourth inner electrode layer 22d.

In the passive electronic component 2A, similarly to the passive electronic component 1A (see FIGS. 1 and 2), the first capacitor 20a preferably further includes the first outer electrode 25a connected to the first inner electrode layer 22a.

In the passive electronic component 2A, similarly to the passive electronic component 1A, the first capacitor 20a preferably further includes the second outer electrode 25b connected to the second inner electrode layer 22b.

In the passive electronic component 2A, unlike the passive electronic component 1A, the second capacitor 20b preferably further includes the third outer electrode 25c connected to the fifth inner electrode layer 22e.

In the example illustrated in FIGS. 15 and 16, the third outer electrode 25c is connected to a portion of the fifth inner electrode layer 22e that does not overlap the third inner electrode layer 22c or the fourth inner electrode layer 22d in the first direction D1.

In the passive electronic component 2A, the third outer electrode 25c preferably does not overlap the third inner electrode layer 22c or the fourth inner electrode layer 22d in plan view in the first direction D1. In this case, since the parasitic capacitance between the third outer electrode 25c and the third inner electrode layer 22c and the parasitic capacitance between the third outer electrode 25c and the fourth inner electrode layer 22d are minimized, the Q value of the passive electronic component 2A is likely to increase.

In the passive electronic component 2A, similarly to the passive electronic component 1A, the second capacitor 20b preferably further includes the fourth outer electrode 25d connected to the fourth inner electrode layer 22d.

In the passive electronic component 2A, the periphery of the fourth outer electrode 25d is preferably located inside the periphery of the fourth inner electrode layer 22d in plan view in the first direction D1. In this case, since the parasitic capacitance between the fourth outer electrode 25d and the third inner electrode layer 22c and the parasitic capacitance between the fourth outer electrode 25d and the fifth inner electrode layer 22e are minimized, the Q value of the passive electronic component 2A is likely to increase.

The passive electronic component 2A is manufactured in the same manner as the passive electronic component 1A except that, for example, the fifth inner electrode layer 22e is also formed in the process of forming the first inner electrode layer 22a. When the fifth inner electrode layer 22e is formed in the process of forming the first inner electrode layer 22a, the first inner electrode layer 22a and the fifth inner electrode layer 22e are preferably formed at the same timing but may be formed at different timings.

In the passive electronic component according to embodiment 2 of the present disclosure, the shapes of the inner electrode layers may differ from those in the example illustrated in FIGS. 15 and 16. In addition, in the passive electronic component according to embodiment 2 of the present disclosure, the positions of the outer electrodes may differ from those in the example illustrated in FIGS. 15 and 16.

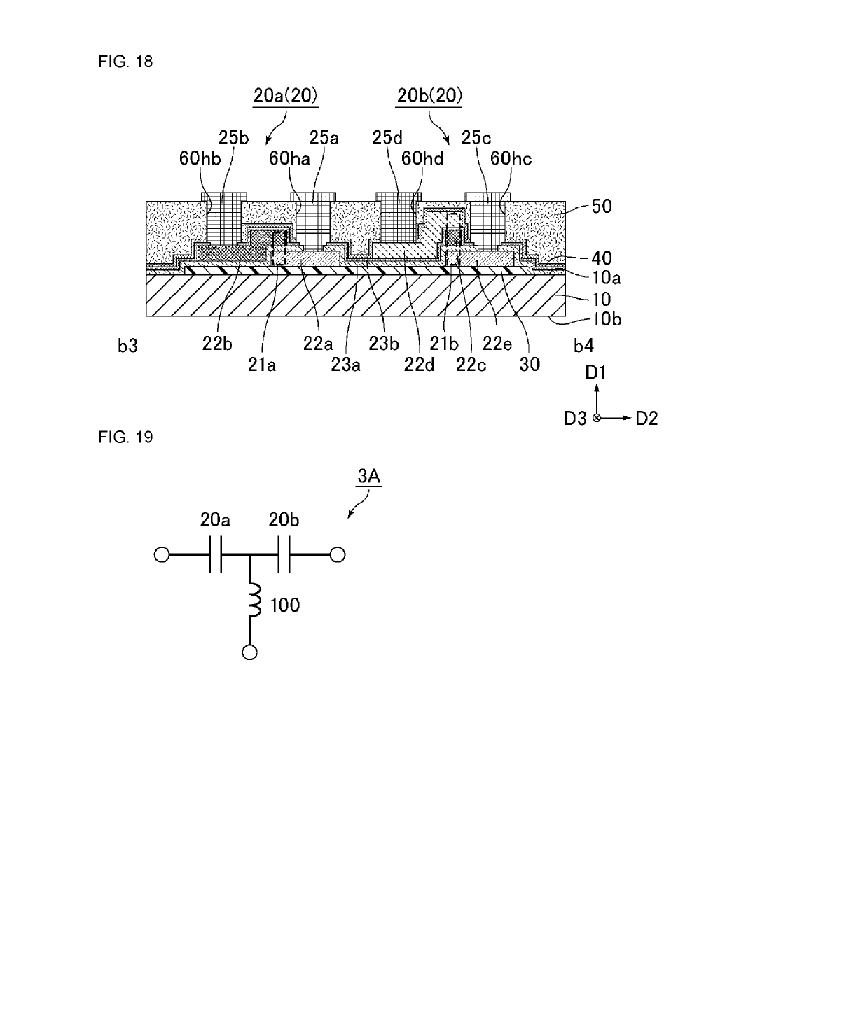

FIG. 17 is a schematic plan view illustrating another example of the passive electronic component according to embodiment 2 of the present disclosure. FIG. 18 is a schematic cross-sectional view illustrating an example of a cross-section of the passive electronic component illustrated in FIG. 17 taken along line segment b3-b4.

In a passive electronic component 2B illustrated in FIGS. 17 and 18, a portion of the second inner electrode layer 22b overlaps the first inner electrode layer 22a in the first direction D1 with the first dielectric layer 23a therebetween.

In the example illustrated in FIG. 18, a step is provided on a surface of the second inner electrode layer 22b on the substrate 10 side. In addition, in the example illustrated in FIG. 18, a step is provided on the surface of the second inner electrode layer 22b on the opposite side from the substrate 10. That is, in the example illustrated in FIG. 18, when the height in the first direction D1 with respect to the first main surface 10a of the substrate 10 is defined, the second inner electrode layer 22b is bent such that a portion on one end side in the second direction D2 has a different height from a portion on the other end side in the second direction D2.

In the passive electronic component 2B, a portion of the fourth inner electrode layer 22d overlaps the third inner electrode layer 22c in the first direction D1 with the second dielectric layer 23b therebetween.

In the example illustrated in FIG. 18, a step is provided on a surface of the fourth inner electrode layer 22d on the substrate 10 side. In addition, in the example illustrated in FIG. 18, a step is provided on the surface of the fourth inner electrode layer 22d on the opposite side from the substrate 10. That is, in the example illustrated in FIG. 18, when the height in the first direction D1 with respect to the first main surface 10a of the substrate 10 is defined, the fourth inner electrode layer 22d is bent such that a portion on one end side in the second direction D2 has a different height from a portion on the other end side in the second direction D2.

In the passive electronic component 2B, the second outer electrode 25b is connected to a portion of the second inner electrode layer 22b that does not overlap the first inner electrode layer 22a in the first direction D1.

In the passive electronic component 2B, the fourth outer electrode 25d is connected to a portion of the fourth inner electrode layer 22d that does not overlap the third inner electrode layer 22c in the first direction D1.

### Embodiment 3

Unlike the passive electronic component according to embodiment 2 of the present disclosure, the passive electronic component according to embodiment 3 of the present disclosure further includes an inductor formed by winding an inner wiring line that includes at least one conductor layer.

In the passive electronic component according to embodiment 3 of the present disclosure, the direction of a winding shaft of the inner wiring line is orthogonal to the first main surface of the substrate, and all the conductor layers each independently contain the same material as the first inner electrode layer, the second inner electrode layer, the third inner electrode layer, the fourth inner electrode layer, the fifth inner electrode layer, the first outer electrode, the second outer electrode, the third outer electrode, or the fourth outer electrode.

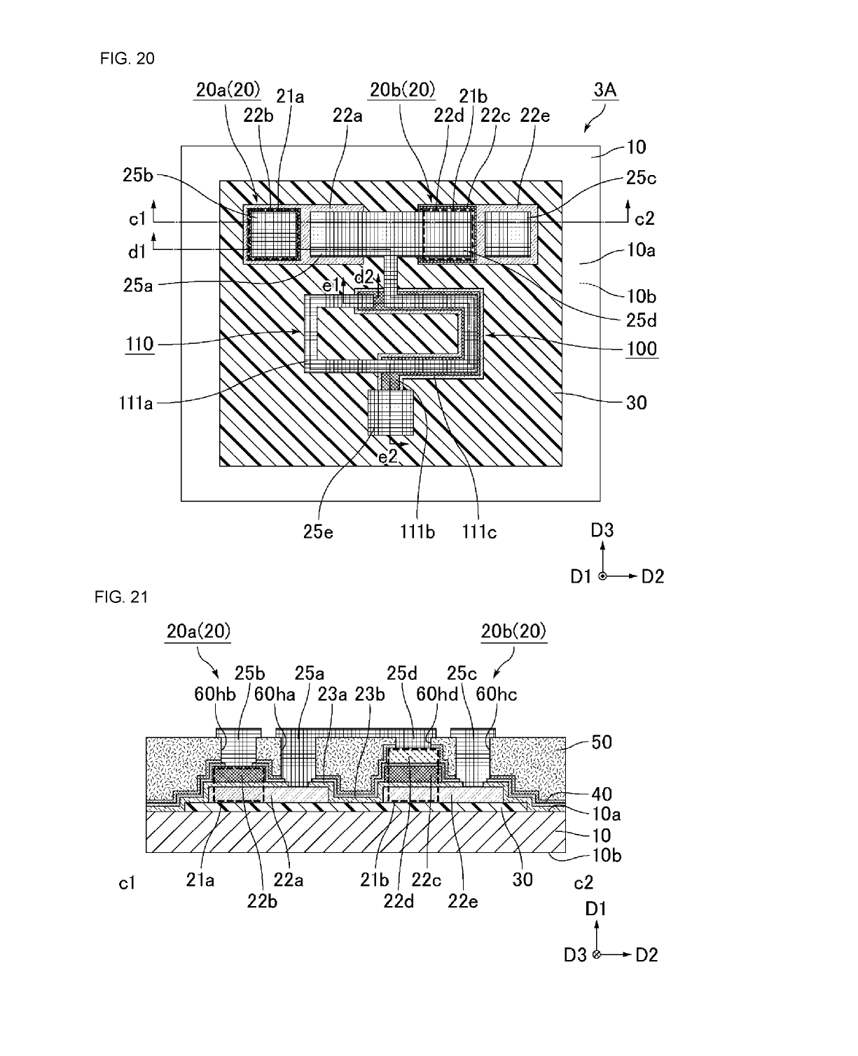

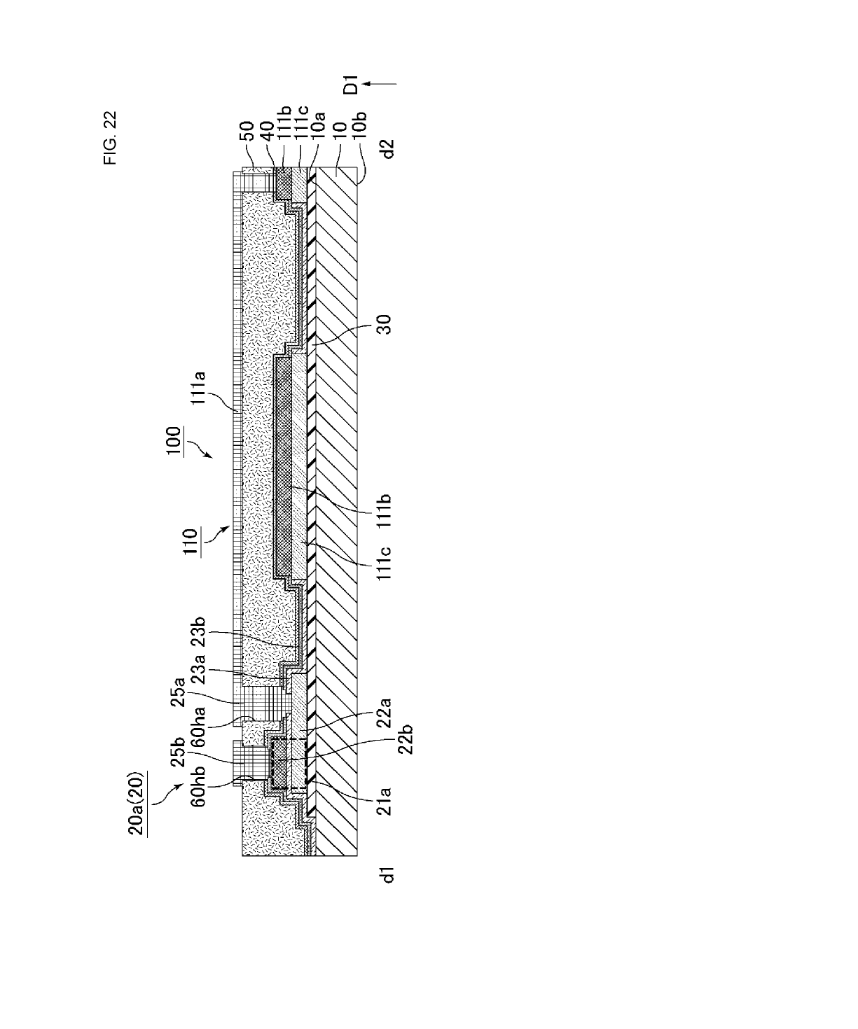

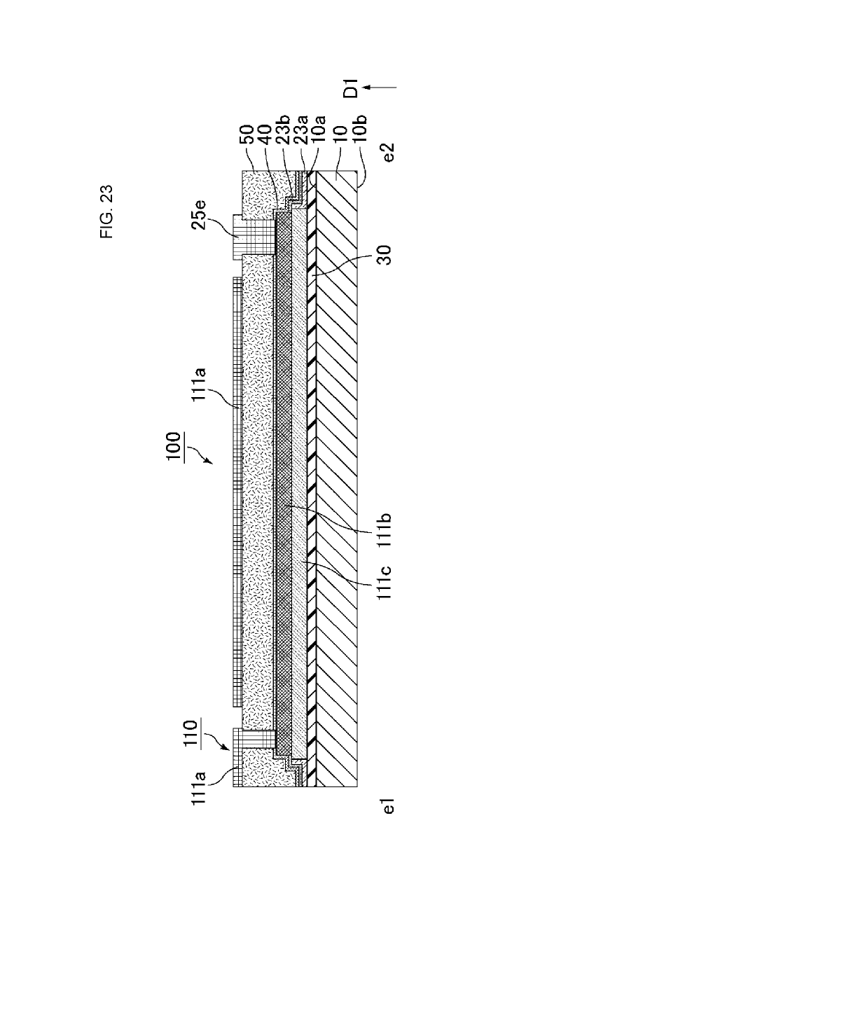

FIG. 19 is an equivalent circuit diagram illustrating an example of the passive electronic component according to embodiment 3 of the present disclosure. FIG. 20 is a schematic plan view illustrating the example of the passive electronic component according to embodiment 3 of the present disclosure. FIG. 21 is a schematic cross-sectional view illustrating an example of a cross-section of the passive electronic component illustrated in FIG. 20 taken along line segment c1-c2. FIG. 22 is a schematic cross-sectional view illustrating an example of a cross-section of the passive electronic component illustrated in FIG. 20 taken along line segment d1-d2. FIG. 23 is a schematic cross-sectional view illustrating an example of a cross-section of the passive electronic component illustrated in FIG. 20 taken along line segment e1-e2.

A passive electronic component 3A illustrated in FIGS. 19, 20, 21, 22, and 23 further includes an inductor 100 in addition to the substrate 10, the first capacitor 20a, and the second capacitor 20b.

The first capacitor 20a and the second capacitor 20b are connected in series to each other. Specifically, the first outer electrode 25a of the first capacitor 20a and the fourth outer electrode 25d of the second capacitor 20b are connected to each other, and accordingly, the first capacitor 20a and the second capacitor 20b are connected in series to each other.

The first capacitor 20a is electrically derived to the outside of the passive electronic component 3A via the second outer electrode 25b.

The second capacitor 20b is electrically derived to the outside of the passive electronic component 3A via the third outer electrode 25c.

One end portion of the inductor 100 is connected to a connection portion between the first capacitor 20a and the second capacitor 20b. Specifically, one end portion of the inductor 100 is connected to a connection portion between the first outer electrode 25a of the first capacitor 20a and the fourth outer electrode 25d of the second capacitor 20b.

As described above, the inductor 100 is connected to both the first capacitor 20a and the second capacitor 20b. It should be noted that the inductor 100 may also be connected to one of the first capacitor 20a and the second capacitor 20b. That is, the inductor 100 may also be connected to at least one of the first capacitor 20a and the second capacitor 20b.

The other end portion of the inductor 100 is connected to a fifth outer electrode 25e. As a result, the inductor 100 is electrically derived to the outside of the passive electronic component 3A via the fifth outer electrode 25e.

The inductor 100 is formed by winding the inner wiring line 110.

The inner wiring line 110 is wound spirally in the direction of the winding shaft.

The direction of the winding shaft of the inner wiring line 110 is orthogonal to the first main surface 10a of the substrate 10.

In the example illustrated in FIGS. 20, 22, and 23, the direction of the winding shaft of the inner wiring line 110 is parallel to the first direction D1. That is, the inner wiring line 110 is wound spirally as viewed in the first direction D1.

The inner wiring line 110 includes at least one conductor layer.

In the example illustrated in FIGS. 20, 22, and 23, the inner wiring line 110 includes three conductor layers: a first conductor layer 111a, a second conductor layer 111b, and a third conductor layer 111c.

In the example illustrated in FIGS. 20, 22, and 23, along the path of the inner wiring line 110 extending from one end side (the side close to the first capacitor 20a and the second capacitor 20b) of the inductor 100 to the other end side (the side opposite to the first capacitor 20a and the second capacitor 20b) of the inductor 100, the first conductor layer 111a and a multilayer body including the second conductor layer 111b and the third conductor layer 111c are sequentially connected together.

All the conductor layers included in the inner wiring line 110 each independently contain the same material as the first inner electrode layer 22a, the second inner electrode layer 22b, the third inner electrode layer 22c, the fourth inner electrode layer 22d, the fifth inner electrode layer 22e, the first outer electrode 25a, the second outer electrode 25b, the third outer electrode 25c, or the fourth outer electrode 25d.

In the example illustrated in FIGS. 20, 21, 22, and 23, the first conductor layer 111a contains the same material as the first outer electrode 25a, the second outer electrode 25b, the third outer electrode 25c, or the fourth outer electrode 25d. In addition, the second conductor layer 111b contains the same material as the second inner electrode layer 22b or the third inner electrode layer 22c. In addition, the third conductor layer 111c contains the same material as the first inner electrode layer 22a or the fifth inner electrode layer 22e.

As described above, since all the conductor layers included in the inner wiring line 110 of the inductor 100 contain the same material as the inner electrode layers or the outer electrodes included in the first capacitor 20a and the second capacitor 20b in the passive electronic component 3A, all the conductor layers can be formed at the same timing as the inner electrode layers or the outer electrodes in the process of manufacturing the passive electronic component 3A. Specifically, the first conductor layer 111a can be formed at the same timing as the first outer electrode 25a, the second outer electrode 25b, the third outer electrode 25c, or the fourth outer electrode 25d. In addition, the second conductor layer 111b can be formed at the same timing as the second inner electrode layer 22b or the third inner electrode layer 22c. In addition, the third conductor layer 111c can be formed at the same timing as the first inner electrode layer 22a or the fifth inner electrode layer 22e. Accordingly, in the process of manufacturing the passive electronic component 3A, the inductor 100 can be formed at the same timing as the first capacitor 20a and the second capacitor 20b.

As described above, in the process of manufacturing the passive electronic component 3A, since the inductor 100 can be formed at the same timing as the first capacitor 20a and the second capacitor 20b, the conductor layers included in the inner wiring line 110 of the inductor 100 can be formed thick as the inner electrode layers included in the first capacitor 20a and the second capacitor 20b. As a result, in the passive electronic component 3A, the Q value of the inductor 100 can be increased.

The passive electronic component 3A is manufactured in the same manner as the passive electronic component 2A except that, for example, the third conductor layer 111c is formed in the process of forming the first inner electrode layer 22a or the fifth inner electrode layer 22e, the second conductor layer 111b is formed in the process of forming the second inner electrode layer 22b or the third inner electrode layer 22c, and the first conductor layer 111a is formed in the process of forming the first outer electrode 25a, the second outer electrode 25b, the third outer electrode 25c, or the fourth outer electrode 25d.

In the passive electronic component according to embodiment 3 of the present disclosure, the number of conductor layers included in the inner wiring line of the inductor is not limited to three described above as long as at least one layer is included.

In the passive electronic component according to embodiment 3 of the present disclosure, the combinations of the materials of all the conductor layers included in the inner wiring line of the inductor is not limited to the combinations described above as long as they are combinations selected from the first inner electrode layer, the second inner electrode layer, the third inner electrode layer, the fourth inner electrode layer, the fifth inner electrode layer, the first outer electrode, the second outer electrode, the third outer electrode, and the fourth outer electrode.

### Embodiment 4

Unlike the passive electronic component of embodiment 2 of the present disclosure, the passive electronic component according to embodiment 4 of the present disclosure further includes an inductor formed by winding an inner wiring line that includes a plurality of conductor layers.

In the passive electronic component according to embodiment 4 of the present disclosure, the direction of the winding shaft of the inner wiring line is parallel to the first main surface of the substrate, and all the conductor layers each independently contain the same material as the first inner electrode layer, the second inner electrode layer, the third inner electrode layer, the fourth inner electrode layer, the fifth inner electrode layer, the first outer electrode, the second outer electrode, the third outer electrode, or the fourth outer electrode.

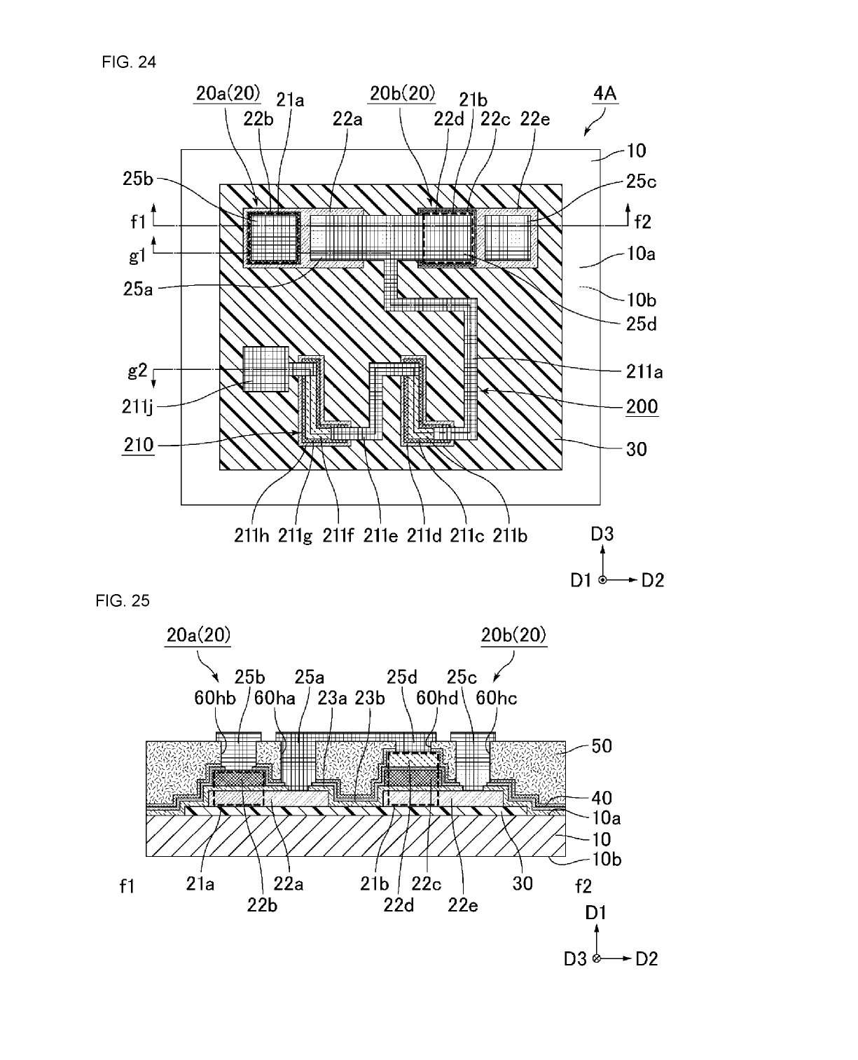

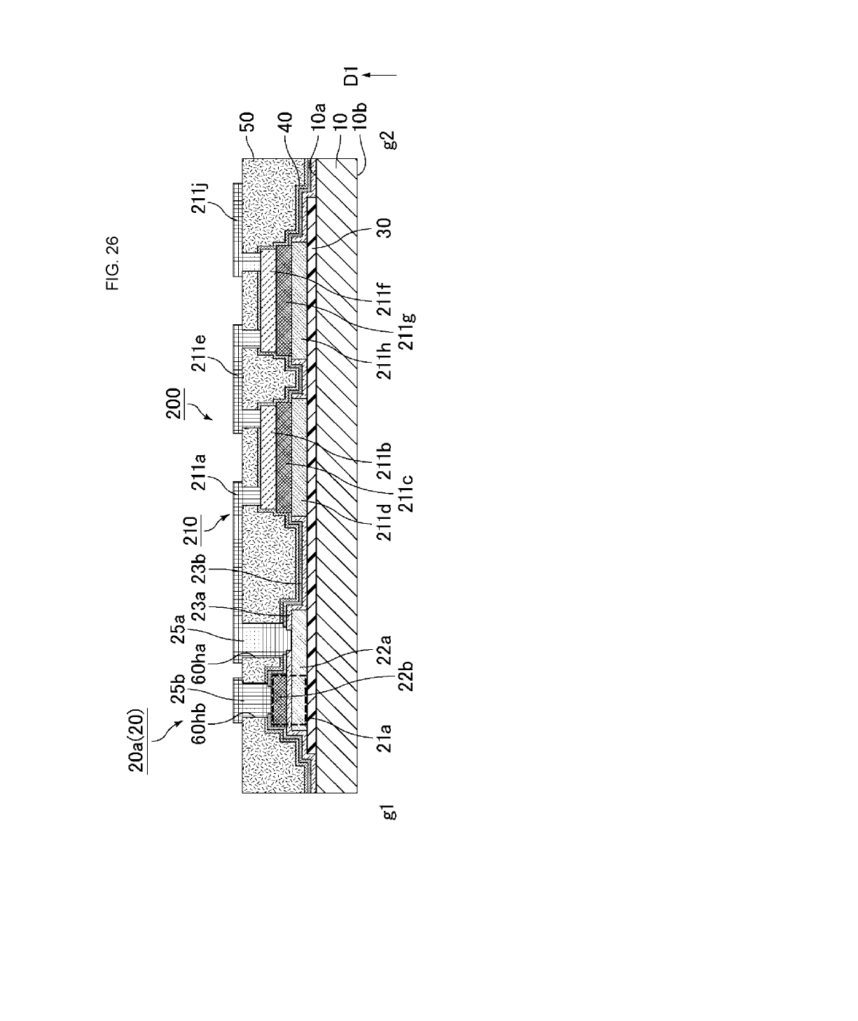

FIG. 24 is a schematic plan view illustrating an example of the passive electronic component according to embodiment 4 of the present disclosure. FIG. 25 is a schematic cross-sectional view illustrating an example of a cross-section of the passive electronic component illustrated in FIG. 24 taken along line segment f1-f2. FIG. 26 is a schematic cross-sectional view illustrating an example of a cross-section of the passive electronic component illustrated in FIG. 24 taken along line segment g1-g2.

A passive electronic component 4A illustrated in FIGS. 24, 25, and 26 further includes an inductor 200 in addition to the substrate 10, the first capacitor 20a, and the second capacitor 20b.

The structures of the first capacitor 20a and the second capacitor 20b of the passive electronic component 4A are the same as those of the first capacitor 20a and the second capacitor 20b of the passive electronic component 3A.

One end portion of the inductor 200 is connected to the connecting portion between the first capacitor 20a and the second capacitor 20b. Specifically, one end portion of the inductor 200 is connected to the connecting portion between the first outer electrode 25a of the first capacitor 20a and the fourth outer electrode 25d of the second capacitor 20b.

As described above, the inductor 200 is connected to both the first capacitor 20a and the second capacitor 20b. It should be noted that the inductor 200 may be connected to one of the first capacitor 20a and the second capacitor 20b. That is, the inductor 200 may be connected to at least one of the first capacitor 20a and the second capacitor 20b.

The inductor 200 is electrically derived to the outside of the passive electronic component 4A on the other end side.

The inductor 200 is formed by winding an inner wiring line 210.

The inner wiring line 210 is wound spirally in the direction of the winding shaft.

The direction of the winding shaft of the inner wiring line 210 is parallel to the first main surface 10a of the substrate 10.

In the example illustrated in FIGS. 24 and 26, the direction of the winding shaft of the inner wiring line 210 is parallel to the second direction D2. That is, the inner wiring line 210 is wound spirally as viewed in the second direction D2.

The inner wiring line 210 includes a plurality of conductor layers.

In the example illustrated in FIGS. 24 and 26, the inner wiring line 210 includes nine conductor layers: a first conductor layer 211a, a second conductor layer 211b, a third conductor layer 211c, a fourth conductor layer 211d, a fifth conductor layer 211e, a sixth conductor layer 211f, a seventh conductor layer 211g, an eighth conductor layer 211h, and a ninth conductor layer 211j.

In the example illustrated in FIGS. 24 and 26, along the path of the inner wiring line 210 extending from one end side (the side close to the first capacitor 20a and the second capacitor 20b) of the inductor 200 to the other end side (the side opposite to the first capacitor 20a and the second capacitor 20b) of the inductor 200, the first conductor layer 211a, a multilayer body including the second conductor layer 211b, the third conductor layer 211c, and the fourth conductor layer 211d, the fifth conductor layer 211e, a multilayer body including the sixth conductor layer 211f, the seventh conductor layer 211g, and the eighth conductor layer 211h, and the ninth conductor layer 211j are sequentially connected together.

All the conductor layers included in the inner wiring line 210 each independently contain the same material as the first inner electrode layer 22a, the second inner electrode layer 22b, the third inner electrode layer 22c, the fourth inner electrode layer 22d, the fifth inner electrode layer 22e, the first outer electrode 25a, the second outer electrode 25b, the third outer electrode 25c, or the fourth outer electrode 25d.

In the example illustrated in FIGS. 24, 25, and 26, the first conductor layer 211a contains the same material as the first outer electrode 25a, the second outer electrode 25b, the third outer electrode 25c, or the fourth outer electrode 25d. In addition, the second conductor layer 211b contains the same material as the fourth inner electrode layer 22d. In addition, the third conductor layer 211c contains the same material as the second inner electrode layer 22b or the third inner electrode layer 22c. In addition, the fourth conductor layer 211d contains the same material as the first inner electrode layer 22a or the fifth inner electrode layer 22e. In addition, the fifth conductor layer 211e contains the same material as the first outer electrode 25a, the second outer electrode 25b, the third outer electrode 25c, or the fourth outer electrode 25d. In addition, the sixth conductor layer 211f contains the same material as the fourth inner electrode layer 22d. In addition, the seventh conductor layer 211g contains the same material as the second inner electrode layer 22b or the third inner electrode layer 22c. In addition, the eighth conductor layer 211h contains the same material as the first inner electrode layer 22a or the fifth inner electrode layer 22e. In addition, the ninth conductor layer 211j contains the same material as the first outer electrode 25a, the second outer electrode 25b, the third outer electrode 25c, or the fourth outer electrode 25d.

As described above, since all the conductor layers included in the inner wiring line 210 of the inductor 200 contain the same material as the inner electrode layers or the outer electrodes included in the first capacitor 20a and the second capacitor 20b in the passive electronic component 4A, all the conductor layers can be formed at the same timing as the inner electrode layers or the outer electrodes in the process of manufacturing the passive electronic component 4A. Specifically, the first conductor layer 211a can be formed at the same timing as the first outer electrode 25a, the second outer electrode 25b, the third outer electrode 25c, or the fourth outer electrode 25d. In addition, the second conductor layer 211b can be formed at the same timing as the fourth inner electrode layer 22d. In addition, the third conductor layer 211c can be formed at the same timing as the second inner electrode layer 22b or the third inner electrode layer 22c. In addition, the fourth conductor layer 211d can be formed at the same timing as the first inner electrode layer 22a or the fifth inner electrode layer 22e. In addition, the fifth conductor layer 211e can be formed at the same timing as the first outer electrode 25a, the second outer electrode 25b, the third outer electrode 25c, or the fourth outer electrode 25d. In addition, the sixth conductor layer 211f can be formed at the same timing as the fourth inner electrode layer 22d. In addition, the seventh conductor layer 211g can be formed at the same timing as the second inner electrode layer 22b or the third inner electrode layer 22c. In addition, the eighth conductor layer 211h can be formed at the same timing as the first inner electrode layer 22a or the fifth inner electrode layer 22e. In addition, the ninth conductor layer 211j can be formed at the same timing as the first outer electrode 25a, the second outer electrode 25b, the third outer electrode 25c, or the fourth outer electrode 25d. Accordingly, in the process of manufacturing the passive electronic component 4A, the inductor 200 can be formed at the same timing as the first capacitor 20a and the second capacitor 20b.

As described above, in the process of manufacturing the passive electronic component 4A, since the inductor 200 can be formed at the same timing as the first capacitor 20a and the second capacitor 20b, the conductor layers included in the inner wiring line 210 of the inductor 200 can be formed thick as the inner electrode layers included in the first capacitor 20a and the second capacitor 20b. As a result, in the passive electronic component 4A, the Q value of the inductor 200 can be increased.

In addition, since the direction of the winding shaft of the inner wiring line 210 of the inductor 200 is parallel to the first main surface 10a of the substrate 10 in the passive electronic component 4A, the amount of magnetic flux that passes through the substrate 10 is smaller than that of the passive electronic component 3A in which the direction of the winding shaft of the inner wiring line 110 of the inductor 100 is orthogonal to the first main surface 10a of the substrate 10. As a result, in the passive electronic component 4A, the Q value of the inductor 200 can be increased.

The passive electronic component 4A is manufactured in the same manner as the passive electronic component 2A except that, for example, the fourth conductor layer 211d and the eighth conductor layer 211h are formed in the process of forming the first inner electrode layer 22a or the fifth inner electrode layer 22e, the third conductor layer 211c and the seventh conductor layer 211g are formed in the process of forming the second inner electrode layer 22b or the third inner electrode layer 22c, the second conductor layer 211b and the sixth conductor layer 211f are formed in the process of forming the fourth inner electrode layer 22d, and the first conductor layer 211a, the fifth conductor layer 211e, and the ninth conductor layer 211j are formed in the process of forming the first outer electrode 25a, the second outer electrode 25b, the third outer electrode 25c, or the fourth outer electrode 25d.

In the passive electronic component according to embodiment 4 of the present disclosure, the number of conductor layers included in the inner wiring line of the inductor is not limited to nine described above as long as a plurality of layers are included.

In the passive electronic component according to embodiment 4 of the present disclosure, the combinations of the materials of all the conductor layers included in the inner wiring line of the inductor is not limited to the combinations described above as long as they are combinations selected from the first inner electrode layer, the second inner electrode layer, the third inner electrode layer, the fourth inner electrode layer, the fifth inner electrode layer, the first outer electrode, the second outer electrode, the third outer electrode, and the fourth outer electrode.

In the embodiment described above, a case in which the whole of the second inner electrode layer and the whole of the third inner electrode layer are in contact with the surface of the first dielectric layer on the opposite side from the substrate, but at least a portion of the second inner electrode layer and at least a portion of the third inner electrode layer only need to be in contact with the surface of the first dielectric layer on the opposite side from the substrate. That is, what is in contact with the surface of the first dielectric layer on the opposite side from the substrate may be a combination of a portion of the second inner electrode layer and a portion of the third inner electrode layer, a combination of the whole of the second inner electrode layer and a portion of the third inner electrode layer, a combination of a portion of the second inner electrode layer and the whole of the third inner electrode layer, or a combination of the whole of the second inner electrode layer and the whole of the third inner electrode layer. For example, in the passive electronic component 1B illustrated in FIG. 14, when a portion of the second inner electrode layer 22b that does not overlap the first inner electrode layer 22a in the first direction D1 is in contact with the insulating layer 30 without intervention of the first dielectric layer 23a, a portion of the second inner electrode layer 22b is in contact with the surface of the first dielectric layer 23a on the opposite side from the substrate 10. In addition, in the passive electronic component 1B illustrated in FIG. 14, when a portion of the third inner electrode layer 22c that does not overlap the fourth inner electrode layer 22d in the first direction D1 is in contact with the insulating layer 30 without intervention of the first dielectric layer 23a, a portion of the third inner electrode layer 22c is in contact with the surface of the first dielectric layer 23a on the opposite side from the substrate 10.

A case in which one passive electronic component includes, as the plurality of capacitors, two capacitors including the first capacitor and the second capacitor has been exemplified in the embodiment described above, but one passive electronic component may also include three or more capacitors including the first capacitor and the second capacitor.

In the passive electronic component according to the present disclosure, for all the capacitors (including the first capacitor and the second capacitor), the capacitor elements constituting the capacitance forming portion each preferably include one dielectric layer without including a multilayer body of plurality of dielectric layers. In the example illustrated in FIG. 2, one capacitor element constituting the first capacitance forming portion 21a of the first capacitor 20a includes one first dielectric layer 23a. In addition, the example illustrated in FIG. 2, one capacitor element constituting the second capacitance forming portion 21b of the second capacitor 20b includes one second dielectric layer 23b.

When the passive electronic component according to the present disclosure includes an insulating layer, the insulating layer is preferably provided between the substrate and all the capacitors (including the first capacitor and the second capacitor) in the first direction.

When the passive electronic component according to the present disclosure includes a moisture-resistant protective layer, the moisture-resistant protective layer preferably covers the capacitance forming portions of all the capacitors (including the first capacitor and the second capacitor).

When the passive electronic component according to the present disclosure includes a resin protective layer, the resin protective layer preferably covers the substrate and the capacitance forming portions of all the capacitors (including the first capacitor and the second capacitor).

### Reference Signs List

1A, 1B, 2A, 2B, 3A, 4A passive electronic component

10 substrate

10a first main surface of substrate

10b second main surface of substrate

20 capacitor

20a first capacitor

20b second capacitor

21a first capacitance forming portion

21b second capacitance forming portion

22a first inner electrode layer

22b second inner electrode layer

22c third inner electrode layer

22d fourth inner electrode layer

22e fifth inner electrode layer

23a first dielectric layer

23b second dielectric layer

25a first outer electrode

25b second outer electrode

25c third outer electrode

25d fourth outer electrode

25e fifth outer electrode

30 insulating layer

40 moisture-resistant protective layer

50 resin protective layer

23ah, 23bha, 23bhb, 23bhc, 40ha, 40hb, 40hc, 40hd, 50ha, 50hb, 50hc, 50hd, 60ha, 60hb, 60hc, 60hd through-hole

100, 200 inductor

110, 210 inner wiring line

111a, 211a first conductor layer

111b, 211b second conductor layer

111c, 211c third conductor layer

211d fourth conductor layer

211e fifth conductor layer

211f sixth conductor layer

211g seventh conductor layer

211h eighth conductor layer

211j ninth conductor layer

D1 first direction

D2 second direction

D3 third direction

R region between first capacitor (first capacitance forming portion) and second capacitor (second capacitance forming portion) in second direction

T1 dimension in first direction of first dielectric layer of first capacitance forming portion

T2 dimension in first direction of second dielectric layer of second capacitance forming portion

1. A passive electronic component comprising:
a substrate having a first main surface and a second main surface that face away from each other in a first direction; and
a plurality of capacitors on a first main surface side of the substrate,
wherein the plurality of capacitors include a first capacitor and a second capacitor spaced apart from the first capacitor in a second direction orthogonal to the first direction,
the first capacitor includes a first capacitance forming portion that includes a first inner electrode layer, a first dielectric layer, and a second inner electrode layer that are arranged sequentially from a substrate side in the first direction,
the second capacitor includes a second capacitance forming portion that includes a third inner electrode layer, a second dielectric layer, and a fourth inner electrode layer that are arranged sequentially from the substrate side in the first direction, and
at least a portion of the second inner electrode layer and at least a portion of the third inner electrode layer are in contact with a surface of the first dielectric layer on an opposite side thereof from the substrate.

2. The passive electronic component according to claim 1, wherein the first dielectric layer of the first capacitance forming portion and the second dielectric layer of the second capacitance forming portion have different dimensions from each other in the first direction.

3. The passive electronic component according to claim 1, further comprising:
a first outer electrode connected to the first inner electrode layer;
a second outer electrode connected to the second inner electrode layer;
a third outer electrode connected to the third inner electrode layer; and
a fourth outer electrode connected to the fourth inner electrode layer.

4. The passive electronic component according to claim 3, wherein a periphery of the second outer electrode is inside a periphery of the second inner electrode layer in a plan view in the first direction.

5. The passive electronic component according to claim 3, wherein a periphery of the fourth outer electrode is inside a periphery of the fourth inner electrode layer in a plan view in the first direction.

6. The passive electronic component according to claim 1, wherein the second capacitance forming portion further includes the first dielectric layer and a fifth inner electrode layer that are arranged sequentially on the substrate side of the third inner electrode layer in the first direction.

7. The passive electronic component according to claim 6, further comprising:
a first outer electrode connected to the first inner electrode layer;
a second outer electrode connected to the second inner electrode layer;
a third outer electrode connected to the fifth inner electrode layer; and
a fourth outer electrode connected to the fourth inner electrode layer.

8. The passive electronic component according to claim 7, wherein a periphery of the second outer electrode is inside a periphery of the second inner electrode layer in a plan view in the first direction.

9. The passive electronic component according to claim 7, wherein a periphery of the fourth outer electrode is inside a periphery of the fourth inner electrode layer in a plan view in the first direction.

10. The passive electronic component according to claim 7, further comprising:
an inductor having a wound inner wiring line that includes at least one conductor layer,
wherein a direction of a winding shaft of the wound inner wiring line is orthogonal to the first main surface of the substrate, and
the at least one conductor layer independently contains a same material as the first inner electrode layer, the second inner electrode layer, the third inner electrode layer, the fourth inner electrode layer, the fifth inner electrode layer, the first outer electrode, the second outer electrode, the third outer electrode, or the fourth outer electrode.

11. The passive electronic component according to claim 7, further comprising:
an inductor having a wound inner wiring line that includes a plurality of conductor layers,
wherein a direction of a winding shaft of the wound inner wiring line is parallel to the first main surface of the substrate, and
the plurality of conductor layers all independently contain a same material as the first inner electrode layer, the second inner electrode layer, the third inner electrode layer, the fourth inner electrode layer, the fifth inner electrode layer, the first outer electrode, the second outer electrode, the third outer electrode, or the fourth outer electrode.

12. The passive electronic component according to claim 1, further comprising:
an insulating layer between the substrate and the first capacitor in the first direction and between the substrate and the second capacitor in the first direction.

13. The passive electronic component according to claim 1, further comprising:
a moisture-resistant protective layer that covers the first capacitance forming portion and the second capacitance forming portion.

14. The passive electronic component according to claim 1, further comprising:
a resin protective layer that covers the substrate, the first capacitance forming portion, and the second capacitance forming portion.

15. The passive electronic component according to claim 13, further comprising:
a resin protective layer that covers the moisture-resistant protective layer, the substrate, the first capacitance forming portion, and the second capacitance forming portion.

16. The passive electronic component according to claim 1, wherein the second inner electrode layer is bent such that a first portion on a first end side thereof in the second direction has a different height from a second portion on a second end side thereof in the second direction.

17. The passive electronic component according to claim 16, wherein the fourth inner electrode layer is bent such that a first portion on a first end side thereof in the second direction has a different height from a second portion on a second end side thereof in the second direction.

18. The passive electronic component according to claim 6, wherein the second inner electrode layer is bent such that a first portion on a first end side thereof in the second direction has a different height from a second portion on a second end side thereof in the second direction.

19. The passive electronic component according to claim 18, wherein the fourth inner electrode layer is bent such that a first portion on a first end side thereof in the second direction has a different height from a second portion on a second end side thereof in the second direction.
